(19) United States
(12) Patent Application Publication
(10) Pub. No.: US 2024/0414416 A1
(43) Pub. Date: Dec. 12, 2024

(54) CONTENT EXPANSION DEVICE USING CODE EMBEDDED IN IMAGE

(71) Applicant: Seong Jung KIM, Seoul (KR)

(72) Inventor: Seong Jung KIM, Seoul (KR)

(21) Appl. No.: 18/273,980

(22) PCT Filed: May 24, 2021
(86) PCT No.: PCT/KR2021/006411

§ 371 Date: Jul. 25, 2023

(30) Foreign Application Priority Data
Jan. 27, 2021 (KR) 10-2021-0011661

(51) Int. Cl. H04N 21/84; H04N 21/835; H04N 21/845

(52) U.S. Cl. CPC H04N 21/84; H04N 21/835; H04N 21/8456

(57) ABSTRACT

Disclosed are a content expansion device and method. A content expansion device according to one embodiment comprises: a receiver for receiving meta information corresponding to a code related to content; and a processor which generates additional information related to the content on the basis of the meta information, combines the additional information with the content so as to generate content combined with the additional information, and provides the content combined with the additional information to a terminal.

### CROSS-REFERENCE TO RELATED APPLICATION

This application is a US National stage Application filed under 35 U.S.C. § 371 of International Application No. PCT/KR2021/006411, filed on May 24, 2021, and designating the United States, the International Application claiming a priority date of Jan. 27, 2021, based on prior Korean Application No. 10-2021-0011661, filed on Jan. 27, 2021, the disclosure of which is incorporated herein by reference in its entirety.

### BACKGROUND

### Technical Field

The following example embodiments relate to a content expansion method and device using a code embedded in an image.

### Related Art

Digital content is a concept that combines digital and content and refers to a concept that generically calls content in which various types of information, such as text, audio, image, and video, which are present in the existing analog form, are digitized in units of bits, 0 and 1. Also, the digital content refers to information that is processed into a digital format using information technology (IT) and used through an information communication network, a digital broadcasting network, and a digital storage medium.

With the development of the Internet and IT, the number of digital contents experienced in daily life is exponentially increasing. Currently, not only large content producers, such as broadcasting companies, but also a large number of individuals participate in producing digital contents, resulting in diversification of content.

However, current digital content is confined to consuming only the digital content itself provided through a user terminal. Therefore, there is a growing need for technology that may provide additional information derivable from the digital content and digital content providing technology that may organically connect an offline environment and an online environment.

### SUMMARY

### Technical Problem

Example embodiments may provide content expansion technology using a code embedded in an image. However, technical subjects are not limited to the aforementioned technical subjects and still other technical subjects may be present.

### Technical Solution

A content expansion device according to an example embodiment includes a receiver configured to receive meta information corresponding to a code related to content; and a processor configured to generate additional information related to the content based on the meta information, to combine the additional information with the content and generate the content combined with the additional information, and to provide the content combined with the additional information to a terminal.

The meta information may include a location of the content, a title of the content, a producer of the content, a playback time of the content, a resolution of the content, capacity of the content, and a playback progress rate of the content.

The processor may be configured to generate a timeline corresponding to a playback progress rate of the content, and to allocate an additional information generation space corresponding to the timeline.

The receiver may be configured to receive a request related to the additional information, and the processor may be configured to search for additional target information in response to the request related to the additional information, and to provide the additional target information to the terminal.

The processor may be configured to determine a target timeline included in the content based on the request related to the additional information, and to search for the additional target information corresponding to the target timeline.

The receiver may be configured to receive an access request for combining the additional information from an additional content provider, and the processor may be configured to set an access right and an edition right for combining the additional information to the additional content provider based on the access request.

The code may include an audio signal, and the processor may be configured to search for the content combined with the additional information based on the audio signal and to provide the same to the terminal.

The additional information may include subtitle information on the content, location information included in the content, purchase information on goods displayed in the content, donation information related to the content, and interior information related to the content.

A content expansion method according to an example embodiment includes receiving content and meta information corresponding to a code related to the content; generating additional information related to the content based on the meta information; combining the additional information with the content and generating the content combined with the additional information; and providing the content combined with the additional information to a terminal.

### BRIEF DESCRIPTION OF DRAWINGS

FIG. 1 is a block diagram illustrating a content expansion device according to an example embodiment.

FIG. 2 schematically illustrates a content expansion operation.

FIG. 3A illustrates an example of a code embedded in an image.

FIG. 3B illustrates another example of a code embedded in an image.

FIG. 3C illustrates an example of a code inserted into a frame.

FIG. 3D illustrates another example of a code inserted into a frame.

FIG. 3E illustrates an operation of turning ON/OFF a code.

FIG. 3F illustrates an infrared (IR) signal when observed with a naked eye.

FIG. 3G illustrates an IR signal when photographed with a smartphone camera.

FIG. 4A illustrates an example of an operation of the content expansion device of FIG. 1.

FIG. 4B illustrates an example of information acquired from a code embedded in an image.

FIG. 4C illustrates another example of information acquired from a code embedded in an image.

FIGS. 5 to 9E illustrate other examples of an operation of the content expansion device of FIG. 1.

FIG. 10 is a flowchart illustrating an operation of the content expansion device of FIG. 1.

FIG. 11 is a schematic block diagram illustrating a content expansion system according to an example embodiment.

FIG. 12 illustrates an example of additional information provided from a content expansion device.

FIG. 13 illustrates an example of a schedule of a content provider.

FIG. 14 illustrates an example of additional information according to a timeline.

FIG. 15 illustrates an example of an additional information generation space.

FIG. 16 illustrates an interaction between a terminal and a content relay server.

FIG. 17 illustrates another example of additional information provided from a content expansion device.

FIG. 18 illustrates an example of describing additional information provided according to a timeline.

FIG. 19 illustrates an example of describing a code recognition operation of a terminal.

FIGS. 20A to 20F illustrate examples of additional information provided from the content expansion device of FIG. 11.

FIG. 21 is a flowchart illustrating an operation of the content expansion device of FIG. 11.

### DETAILED DESCRIPTION

The following structural or functional descriptions of example embodiments described herein are merely intended for the purpose of describing the example embodiments described herein and may be implemented in various forms. Therefore, it should be understood that these example embodiments are not construed as being limited to the illustrated forms and should be understood to include all changes, equivalents, and replacements within the idea and the technical scope of the disclosure.

Although terms of “first,” “second,” and the like are used to explain various components, the terms are used only to distinguish one component from another component. For example, a first component may be referred to as a second component, or similarly, the second component may be referred to as the first component.

When it is mentioned that one component is “connected” or “accessed” to another component, it may be understood that the one component is directly connected or accessed to another component or that still other component is interposed between the two components.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, the example embodiments will be described in detail with reference to the accompanying drawings. When describing the example embodiments with reference to the accompanying drawings, like reference numerals refer to like components and a repeated description related thereto will be omitted.

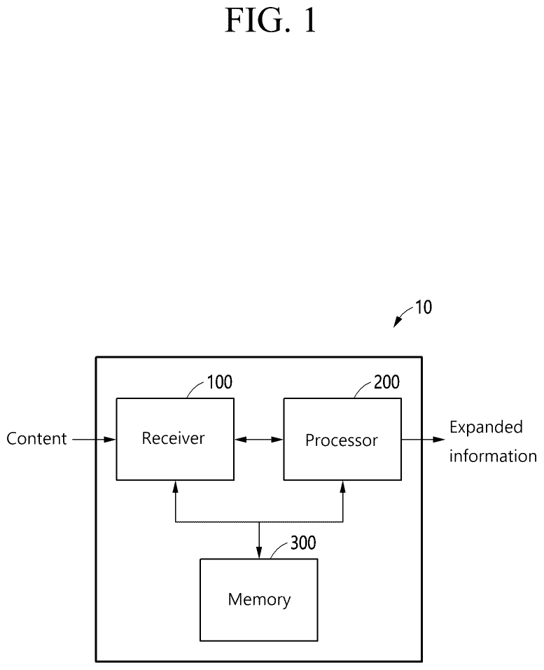

FIG. 1 is a block diagram illustrating a content expansion device according to an example embodiment.

Referring to FIG. 1, a content expansion device 10 may provide expanded information based on content. The expanded information may include expanded content.

Content (contents) may refer to an intangible result in which a cultural material is specifically processed and embedded in media. The content may include visual content and auditory content. The visual content may include a video or an image. The video may include a plurality of images as frames.

The content expansion device 10 may process the content, may generate the expanded content, and may provide the expanded content to a content user. The content expansion device 10 may generate the expanded content based on a code embedded in the content and may provide expanded information related to the content to the user.

The content expansion device 10 may be implemented in a content providing device that includes a display. Alternatively, the content expansion device 10 may be implemented in a server outside the content providing device. The content expansion device 10 may be implemented in a personal computer (PC), a data server, or a portable device.

The portable device may be implemented as a laptop computer, a mobile phone, a smartphone, a tablet PC, a mobile Internet device (MID), a personal digital assistant (PDA), an enterprise digital assistant (EDA), a digital still camera, a digital video camera, a portable multimedia player (PMP), a personal navigation device or a portable navigation device (PND), a handheld game console, an e-book, or a smart device. The smart device may be implemented as a smart watch, a smart band, or a smart ring.

The content expansion device 10 includes a receiver 100 and a processor 200. The content expansion device 10 may further include a memory 300.

The receiver 100 may include a receiving interface. The receiver 100 may include a camera that is implemented as an image sensor. The receiver 100 may receive content and an image or a frame included in the content. The camera included in the receiver 100 may receive the content and the image or the frame included in the content by capturing the content and the image or the frame included in the content. The image may include an augmented reality (AR) image or a virtual reality (VR) image.

The receiver 100 may receive a request related to the content from the user of the content. The receiver 100 may receive a request related to a viewpoint of the content from the user of the content. The receiver 100 may receive a request related to a plot of the content. The receiver 100 may output the request related to the viewpoint of the content and the request related to the plot to the processor 200.

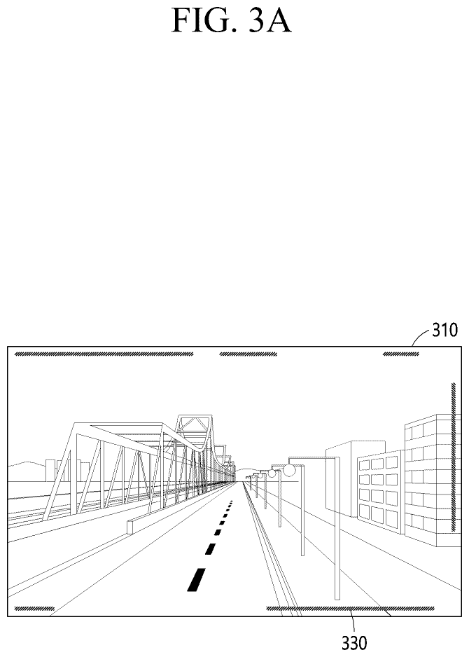

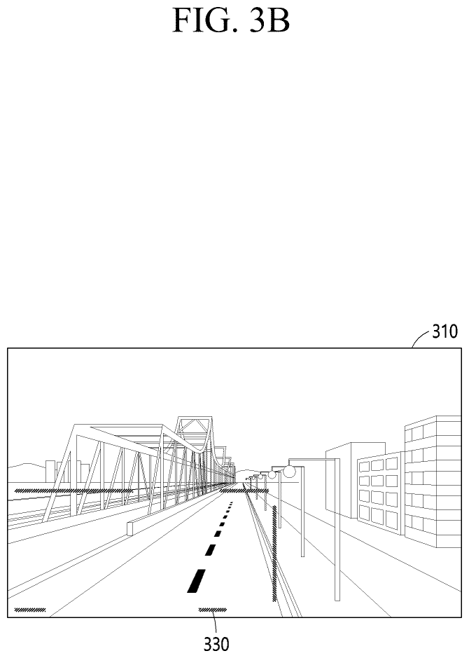

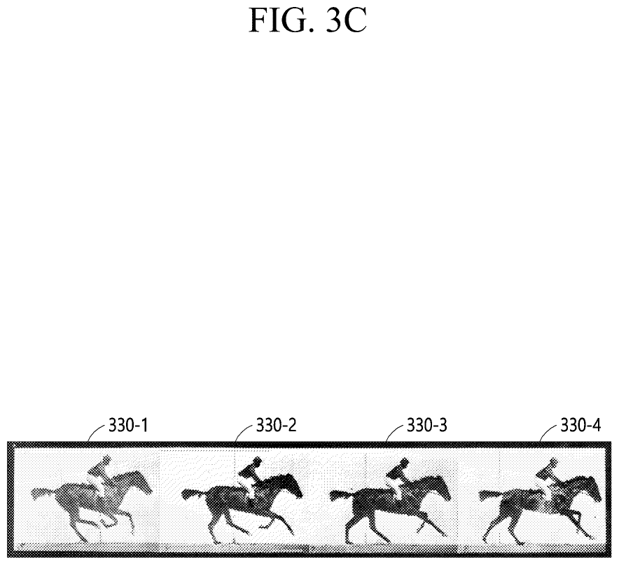

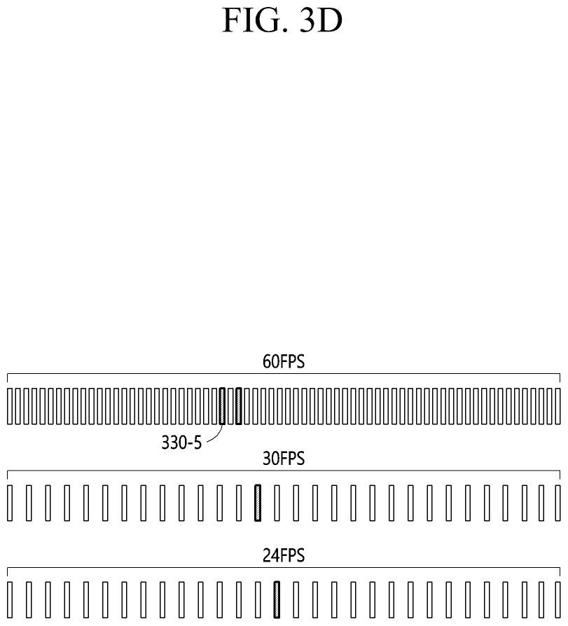

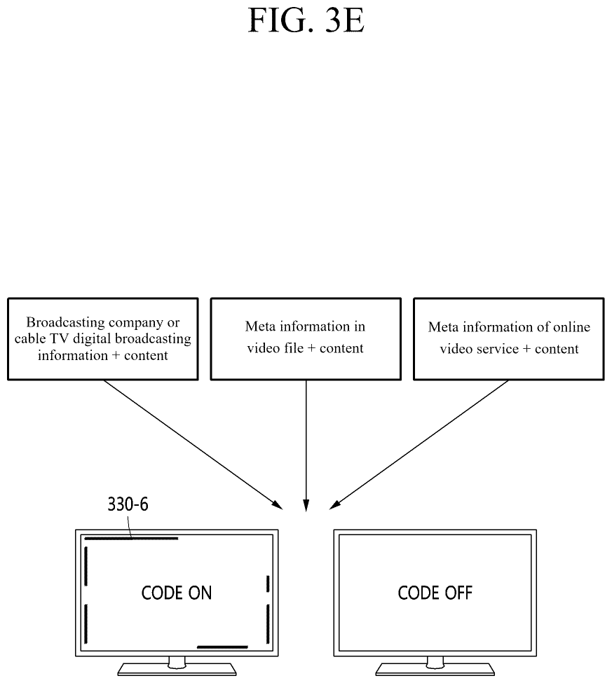

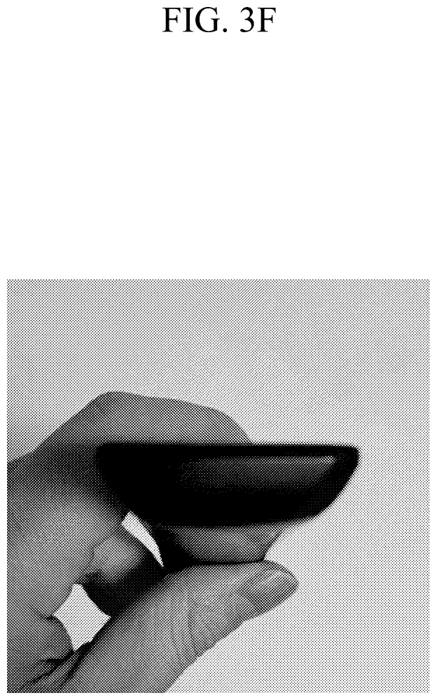

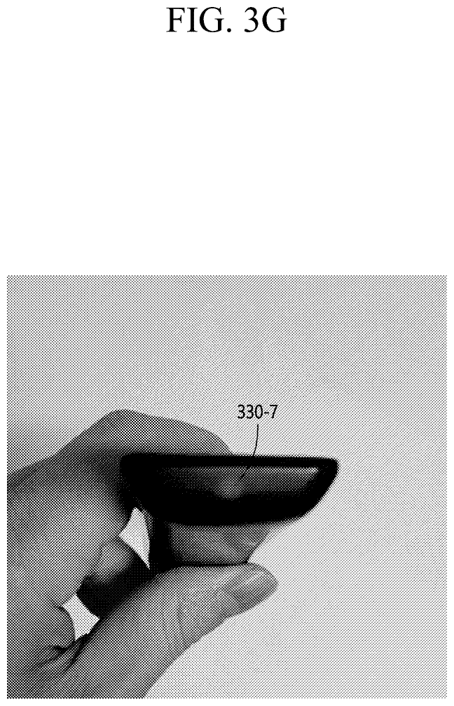

A code corresponding to information related to the content may be embedded in the content and the image or the frame included in the content. The code is further described with reference to FIGS. 3A and 3B. The receiver 100 may receive the image embedded with the code corresponding to the information related to the content. The receiver 100 may output the received content and the image or the frame included in the content to the processor 200.

The processor 200 may process data stored in the memory 300. The processor 200 may execute a computer-readable code (e.g., software) stored in the memory 300 and instructions triggered by the processor 200.

The “processor 200” may be a hardware-implemented data processing device having circuitry in a physical structure for executing desired operations. For example, the desired operations may include instructions or a code included in a program.

For example, the hardware-implemented data processing device may include a microprocessor, a central processing unit, a processor core, a multi-core processor, a multiprocessor, an application-specific integrated circuit (ASIC), and a field programmable gate array (FPGA).

The processor 200 may acquire information related to the content by processing the code embedded in the image. The code embedded in the image may be identified by capturing using an image sensor.

The information related to the content may include source information of the content, a playback time of the content, a playback progress rate of the content, location information related to the content, information related to an object included in the content, and an angle of a camera at which the content is captured. The information related to the content may include information on a subtitle of the content, commentary on the content, and additional content related to the content. For example, the additional content may include a video, music, an image, and a game

The source information of the content may include information on a content provider and a name of the content. The source information of the content may include information on a content file or an Internet address of the content provider. For example, the Internet address may include a uniform resource locator (URL) or an Internet protocol (IP) address of the content provider.

The playback progress rate of the content may represent a length of the content viewed by the content user compared to a playback time of the entire content. The location information related to the content may include information on a place in which an image provided from the content is captured. For example, the location information related to the content may include global positioning system (GPS) coordinates.

The information related to the object included in the content may include information on a person or goods appearing in the content. Information on the person that appears in the content may include a name, an age and an occupation of the person. Information on the goods that appear in the content may include a name, a price, and a purchase place of the goods.

The processor 200 may acquire an Internet address that includes the information related to the content by decoding the code embedded in the image and may acquire the information related to the content based on the Internet address.

The processor 200 may expand information of the content based on the information related to the content and may acquire expanded content that includes additional information related to the content.

The processor 200 may receive an image included in content that is provided from the content providing device present outside the processor 200. The image received by the processor 200 may include at least a portion of content provided from a first content providing device. The processor 200 may continuously provide the content to a second content providing device based on source information of the content and a playback progress rate of the content included in the information on the content.

The processor 200 may adjust a playback progress rate of the second content providing device to be the same as the playback progress rate of the content provided from the first content providing device, such that the content being played back in the first content providing device may be continuously viewed through the second content providing device. That is, continuously providing the content may represent synchronizing playback progress rates such that the content may be continued and viewed in different content providing devices.

The second content providing device may be physically separated from the processor 200 or may be physically connected thereto. For example, the second content providing device may be included in the content expansion device and the second content providing device may include the processor 200.

The processor 200 may provide the expanded content. The processor 200 may provide the expanded content to the content user. For example, the processor 200 may transmit the expanded content to a terminal of the content user or may display the expanded content through a display device of the terminal of the content user.

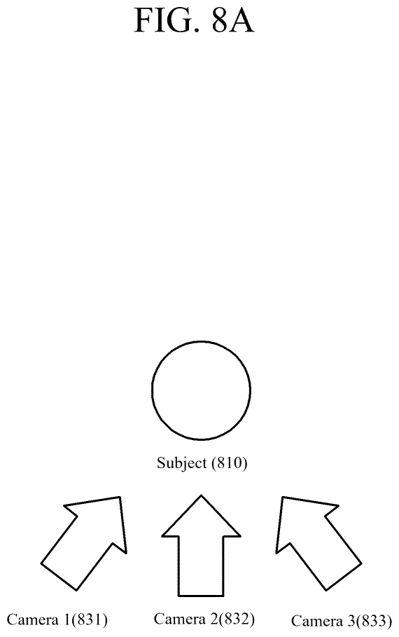

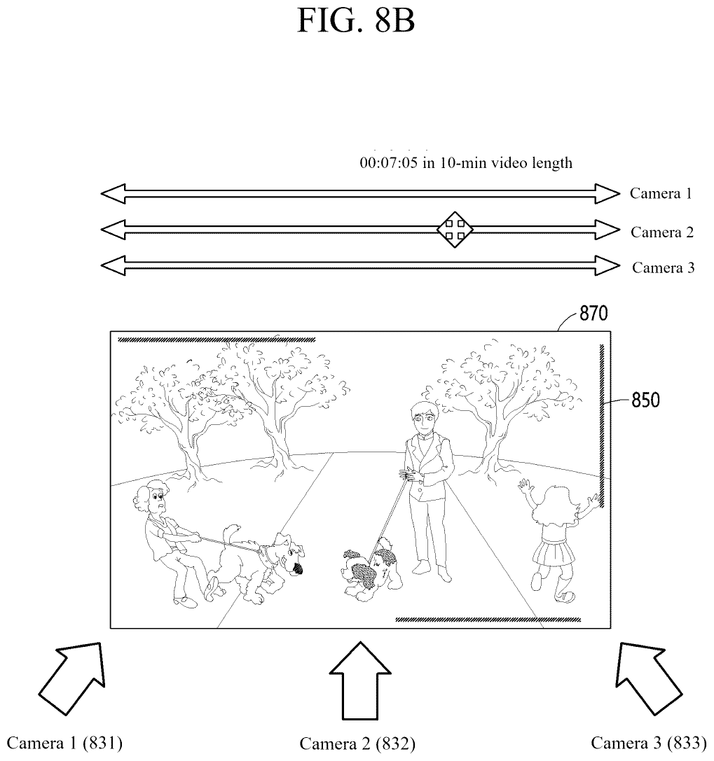

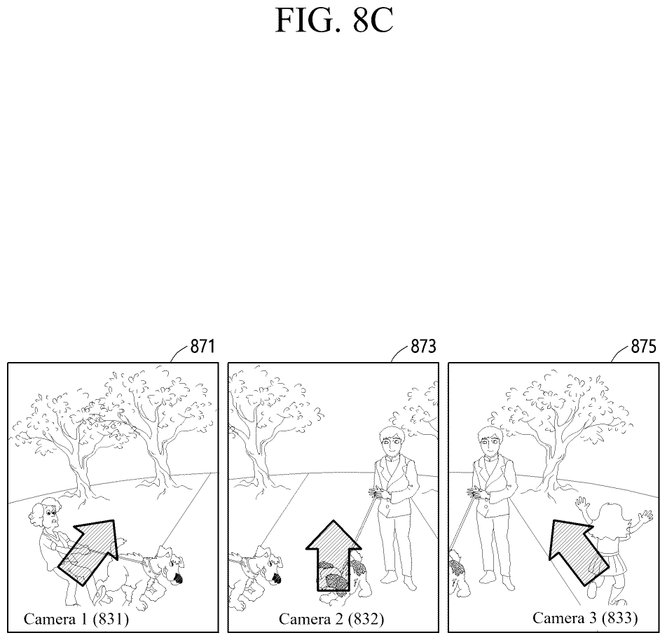

The processor 200 may acquire a plurality of viewpoint contents corresponding to angles of a plurality of cameras at which the content is captured based on information related to the content. The processor 200 may receive a request related to a viewpoint of the content, and may provide at least one viewpoint content among the plurality of viewpoint contents to the user based on the received request. Providing of the viewpoint content is further described with reference to FIGS. 8A to 8C.

The processor 200 may acquire a plurality of sub-contents having different plots in the content based on the information related to the content. The processor 200 may provide at least one sub-content among the plurality of sub-contents to the user based on a request related to the plot of the content. Each of the plurality of sub-contents may have a different ending.

The processor 200 may generate additional information related to the content. The additional information may include information related to a person included in the content, information related to goods included in the content, and information related to a place included in the content.

The information related to the person may include a name, an age, and an occupation of the person. The information related to the goods may include a name, a price, and a purchase place of the goods. The information related to the place may include an address of the place, a transportation to reach the place, an amount of time used to reach the place, and price to use the transportation.

The processor 200 may generate an additional code by encoding the additional information. The processor 200 may insert the additional code into the content. For example, the processor 200 may insert the additional code into a frame or an image corresponding to an arbitrary viewpoint of the content. The additional code may include a tag corresponding to a scene and sound included in the content. The tag may be different depending on a generator of the additional information.

The memory 300 may store instructions (or program) executable by the processor 200. For example, the instructions may include instructions for executing an operation of the processor and/or an operation of each component of the processor.

The memory 300 may be implemented as a volatile memory device or a nonvolatile memory device.

The volatile memory device may be implemented as a dynamic random access memory (DRAM), a static random access memory (SRAM), a thyristor RAM (T-RAM), a zero capacitor RAM (Z-RAM), or a twin transistor RAM (TTRAM).

The nonvolatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate memory (NFGM), a holographic memory, a molecular electronic memory device, or an insulator resistance change memory.

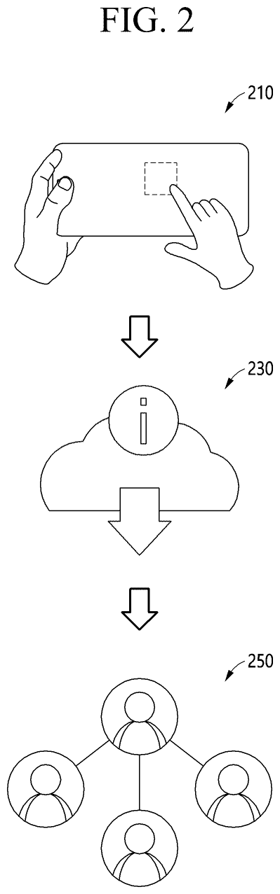

FIG. 2 schematically illustrates a content expansion operation.

Referring to FIG. 2, a receiver (e.g., receiver 100 of FIG. 1) may include a camera implemented as an image sensor. A content user may receive a code embedded in content by capturing the content using an arbitrary terminal (e.g., smartphone) (210). The receiver 100 may output the received code to a processor (e.g., processor 200 of FIG. 1).

The processor 200 may acquire information related to the content by processing the code. The information related to the content may include source information of the content, a playback time of the content, a playback progress rate of the content, location information related to the content, information related to an object included in the content, and an angle of a camera at which the content is captured. The processor 200 may acquire the information related to the content using an Internet address encoded in the code by processing the code.

The processor 200 may download or stream a file including the content through a file relay service based on the source information of the content. The processor 200 may receive additional information added by another content user by processing the code.

The processor 200 may download the information related to the content and may store the same in the memory 300 (230). The processor 200 may generate additional information in the content. The processor 200 may store the generated additional information in the memory 300. The processor 200 may generate an additional code by encoding the additional information. The processor 200 may insert the additional code into the content.

The processor 200 may share the additional information with other content users by distributing the content into which the additional content is inserted (250). The processor 200 may share the content into which the additional code is inserted using a peer-to-peer (P2P) network.

Since the processor 200 acquires information related to the content by processing a code embedded in an image without simply searching for the received image, the processor 200 may quickly and accurately acquire information related to the content compared to simply searching for the image. Also, the processor 200 may accurately provide a variety of information to many users by allowing content users themselves to insert additional information into the content.

The processor 200 may create additional revenue for the content by inserting and distributing the additional information into the content through participation of a plurality of users. The processor 200 may contribute to diversifying a revenue model related to the content using the expanded content generated by insertion of the additional information and newly creating information related to the content without depending on a specific platform.

The processor 200 may allow people other than an initial creator of the content to insert additional information into the content, rapidly increasing an amount of information acquirable from the content.

An initial content creator may have an edition right, that is, a right to edit information related to the content acquirable through the code. The processor 200 may expand the content by inserting the additional information into the content that is distributed by the initial content creator and may provide the expanded content by updating the information related to the content using information added by various users.

The processor 200 may verify the expanded content and may evaluate the content based on information added to the expanded content. The processor 200 may preferentially display content with a high evaluation result to the user.

The processor 200 may create derived revenue related to the content by allowing a content user to generate expanded content through active participation. The processor 200 may calculate cost used for the additional information and may provide the same to the content user.

FIGS. 3A and 3B illustrate examples of a code embedded in an image. FIGS. 3C and 3D illustrate examples of a code inserted into a frame. FIG. 3E illustrates an operation of turning ON/OFF a code. FIG. 3F illustrates an infrared (IR) signal when observed with a naked eye, and FIG. 3G illustrates an IR signal when photographed with a smartphone camera.

Referring to FIGS. 3A to 3G, an image 310 may contain a code 330. The code 330 may include a rule for expressing a specific form of information in a different form. The code 330 may represent data in which information related to the content is encoded.

The code 330 may be inserted only into the image 310 corresponding to some frames not all frames. The code 330 may be inserted between one frame and a next frame of the one frame.

The code 330 may be embedded in the content in a form of a set of pixels included in the image 310. The code 330 may be encoded based on a length of pixels that include the code 330, a ratio of the length of pixels that include the code 330 to a size of the image 310, a color temperature of pixels that include the code 330, and a shape of a set of pixels that constitute the code 330. Although the code 330 is expressed as being identifiable in the examples of FIGS. 3A and 3B, the code 330 embedded in the image 310 may be inserted to be unidentifiable with a naked eye. For example, the code 330 may be provided using a light emitting diode (LED) that is not identified with a naked eye and identified only with a camera.

A processor (e.g., processor 200 of FIG. 1) may insert the code 330 in an arbitrary area of the image 310. FIG. 3A may represent a case in which the code 330 is inserted in an outer area (or edge area) of the image 310 and FIG. 3B may represent a case in which the code 330 is inserted into an internal area of the image 310.

The processor 200 may insert the code 330 into the content using a separate program. For example, the processor 200 may insert the code 330 using an active-x or plug-in-typed program of Internet browser.

The processor 200 may insert the code 330 into the content using a hard coding method. The processor 200 may insert the code 330 into the content using an On Screen Display (OSD) method. Alternatively, the processor 200 may insert the code 330 into original content using a plug-in or relay application and may provide the same to the content user.

The processor 200 may insert the code 330 at a point in time at which the content is encoded. The processor 200 may insert the code 330 using a separate engine at a point in time at which the content is uploaded.

The code 330 may be inserted into a photo or a frame edge using paint that is recognizable only with the camera. The code 330 may be displayed in a form invisible to a human eye on the exhibit in an exhibition hall. In this case, the processor 200 may provide information on the exhibit through the code 330. If it is irrelevant even though the code 330 is recognized by the eye of the human, the code 330 may be inserted in a form recognizable by both the human and the camera.

If the photo is a part of a video, the processor 200 may continuously play back the video from a point at which the photo is included based on the code 330 and may provide a behind story related to the photo to the content user.

The code 300 may be inserted into an edge of goods included in the image and may provide information related to the goods. Through this, the processor 200 may provide information related to the goods without displaying a separate code (e.g., quick read (QR) code).

The processor 200 may distinguish whether a target that is captured by the camera is an image provided through a display device or an object captured without using the display device, and may recognize a code in a form suitable for a code included in the image provided through the display device and a code included in the object captured without using the display device.

The code 330 may be encoded in a form of a sound wave and thereby inserted into the content. For example, the code 330 may be encoded in a frequency outside audible frequency range and inserted into the content. The processor 200 may use a hardware filter or a software filter to identify the code.

The code 330 may include a unique code value corresponding to a single image 310.

As in the examples of FIGS. 3C and 3D, the processor 200 may insert a code into a single frame 330-2 among a plurality of frames 330-1 to 330-4 that constitutes video content. The processor 200 may insert a code into the frame 330-2 in a process of encoding a video. The code inserted into the frame 330-2 may be recognized using a specific function (e.g., slow motion function) of the camera. The processor 200 may insert a frame that includes only the code without including an image into the video.

The processor 200 may insert a code 330-5 into an arbitrary frame of a video having an arbitrary frame rate. For example, the frame rate may be 60 fps, 30 fps, or 24 fps. The higher the frame rate, the lower a probability that the inserted code 330-5 is recognized by a human.

As in the example of FIG. 3E, a code 330-6 may be added to content by transmitting only a digital signal, without being directly overlaid on an image. When the code 330-6 and information included in the code 330-6 are transmitted with the content, the content user may verify the transmitted content and information related to the content even in an offline situation.

The code 330-6 may include broadcasting company or cable TV digital broadcasting information. The code 330-6 may include meta information within a video file and meta information of an online image service.

The processor 200 may turn ON or OFF the code 330-6. The processor 200 may turn ON or OFF the code 330-6 through a device (e.g., TV) that receives the content. If the code is turned OFF, it may not be recognized even by the camera.

The example of FIG. 3F may represent a case in which an infrared data association (IRDA) port of a remote controller is verified with a naked eye. As in the example of FIG. 3F, if a code 330-7 has an IR form, a human may not recognize the code 330-7.

The processor 200 may provide the code 330-7 to a viewer using light in an IR area as well as a visible light area using a light emitting device (e.g., LED) mounted to a display. The light of the IR area may be identified by a camera implemented as a complementary metal-oxide semiconductor (CMOS) or a charge-coupled device (CCD).

If the code is smeared with a different brightness, color temperature, or frequency difference according to a type of the display, the processor 200 may identify the code 330-7 by filtering a specific display area based on the brightness or by adjusting intensity of a software filter that emphasizes only a specific frequency area.

The processor 200 may provide the code 330-7 through a display device (e.g., LED TV), and may receive the code 330-7 through a camera (e.g., smartphone camera). In this case, a separate signal system applicable to provide the code 330-7 may be used through the display device.

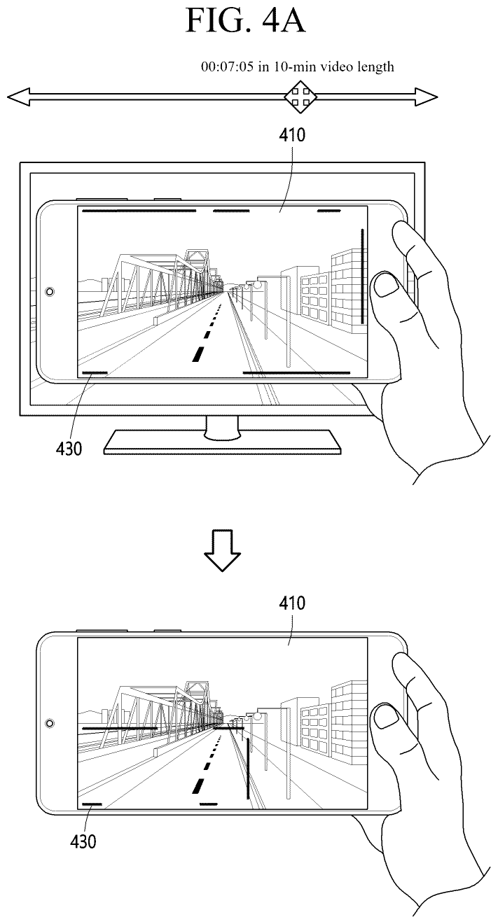

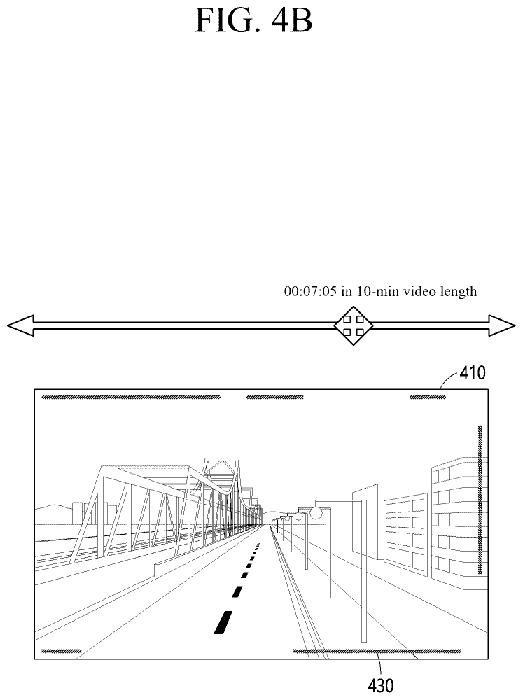

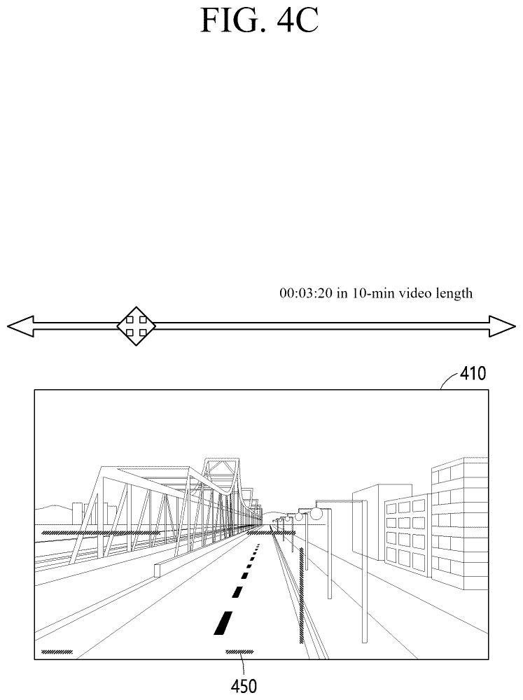

FIG. 4A illustrates an example of an operation of the content expansion device of FIG. 1, and FIGS. 4B and 4C illustrate examples of information acquired from a code embedded in an image.

Referring to FIGS. 4A to 4C, an image 410 included in content may include at least a portion of content provided from a first content providing device.

A user may acquire a code 430 by capturing the content provided from the first content providing device using a camera of a second content providing device. A receiver (e.g., receiver 100 of FIG. 1) of the second content providing device may output the acquired image 410 to a processor (e.g., processor 200 of FIG. 1).

The processor 200 may continuously provide the content to the second content providing device based on source information of the content and a playback progress rate of the content that are included in information related to the content.

The code 430 may be identified through capturing using a camera to which a specific camera application or camera engine is loaded. The code 430 may include an Internet address that indicates the information related to the content. The processor 200 may acquire a name of the content and a location at which the content is captured by processing the code 430.

The code 430 may vary according to a playback location of the content and a scene of the content. Since the playback progress rate of the content has a unique value, the content may be viewed from a time corresponding to a desired progress rate although the code is processed using an arbitrary content providing device.

If the playback progress rate of the content varies, the processor 200 may change a location of the code 430 to a location of a code 450. That is, the processor 200 may differently adjust a location at which the code 430 or the code 450 inserts and a form of the code 430 and the code 450 according to a progress time of the content.

After the processor 200 continuously plays back content that is played back in the first content providing device as second content, the processor 200 may change a content playback progress rate in response to control of a content user. That is, the processor 200 may change a playback point in time of video in response to control of the content user.

The processor 200 may capture a video being transmitted in real time with the second content providing device, such that the content user may continuously view the content or may provide content of which broadcasting is terminated or that is broadcasted ahead of time, to the content user.

For example, the receiver 100 may receive a music file image or a folder image of a music file being displayed in the first content providing device and may output the music file image or the folder image of the music file to the processor 200. The processor 200 may provide music through the second content providing device by processing a code embedded in the folder image.

The processor 200 may provide music included in content being played back in the first content providing device to the second content providing device. The processor 200 may process the code 430 and may provide information related to the music being played back in the first content providing device to the second content providing device. For example, information related to the music may include information on a title of music, artist, a playback time, a playback progress rate of music, and another content in which the same music is used.

The processor 200 may provide information related to the first content providing device through the second content providing device. For example, the processor 200 may process the code by capturing information related to the content being played back in the first content providing device with the second content providing device and may provide information related to the content through the second content providing device, or may provide a game related to the content provided from the first content providing device.

On the contrary, the processor 200 may provide information related to content provided from the second content providing device through the first content providing device. For example, the processor 200 may continuously play back content being played back in the second content providing device through first content. Here, information related to a code or the content may be transmitted from the second content providing device to the first content providing device through wireless communication (e.g., wireless fidelity (WiFi), near field communication (NFC), or Bluetooth).

The content expansion device 10 may be implemented in a content providing device. That is, the content providing device itself may download a database that includes information related to content through ground waves or may download a database that includes information related to the content through the Internet and may insert a code into the content. The content providing device may provide the content excluding a code received through ground waves.

The content providing device may retransmit the received code to the content user through wireless communication (e.g., WiFi or Bluetooth). When the content expansion device 10 is implemented in the content providing device, the content expansion device 10 may be turned ON or OFF by manipulating the content providing device.

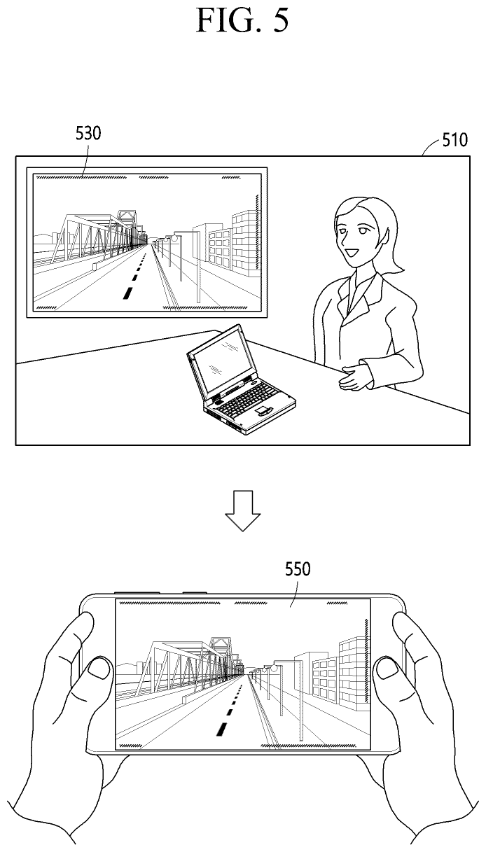

FIG. 5 illustrates another example of an operation of a content expansion device.

Referring to FIG. 5, a processor (e.g., processor 200 of FIG. 1) may process a code 530 included in second content being played back within first content and may provide expanded content. The first content may be played back using a first content providing device. For example, the first content providing device may include an arbitrary display device.

The second content may represent content that is included in the first content and thereby played back. A receiver (e.g., receiver 100 of FIG. 1) may receive a first image 510 included in the first content captured using a camera. The processor 200 may acquire information related to the second content by processing the code 530 embedded in a second image 550 that is included in the first image 510.

The processor 200 may generate expanded second content for the second content included in the first content. The processor 200 may provide the second content through the second content providing device based on information related to the second content. For example, the processor 200 may provide the expanded content by processing a code embedded in a picture in picture (PIP) image. For example, the processor 200 may provide a game application related to the second content to a content user.

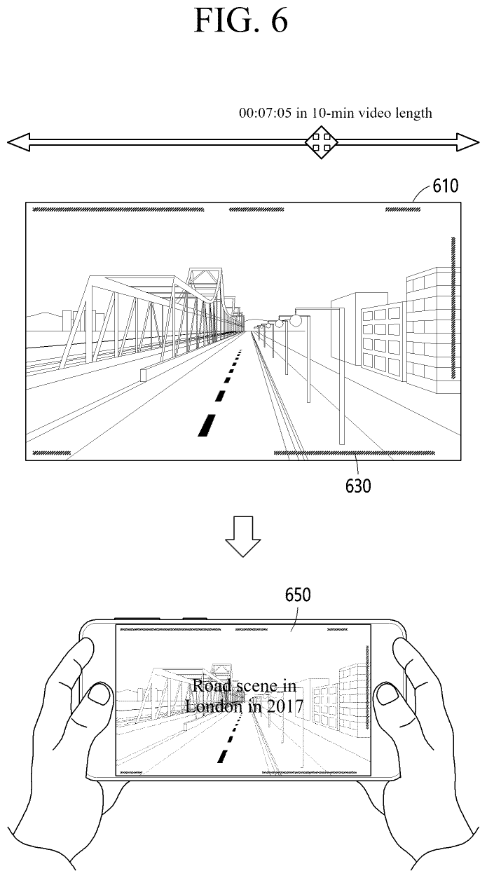

FIG. 6 illustrates still other examples of an operation of the content expansion device of FIG. 1.

Referring to FIG. 6, a processor (e.g., processor 200 of FIG. 1) may provide information related to a time and a place at which content is captured based on a code 630 embedded in an image 610. The processor 200 may acquire information related to content that includes the image 610 by processing the code 630 and may acquire expanded content 650 that includes additional information by expanding information of the content based on the information related to the content.

For example, the processor 200 may generate the expanded content 650 with additional information indicating that the image 610 is a road scene in London in 2017 using information acquired by processing the code 630 and may provide the expanded content 650 to a content user.

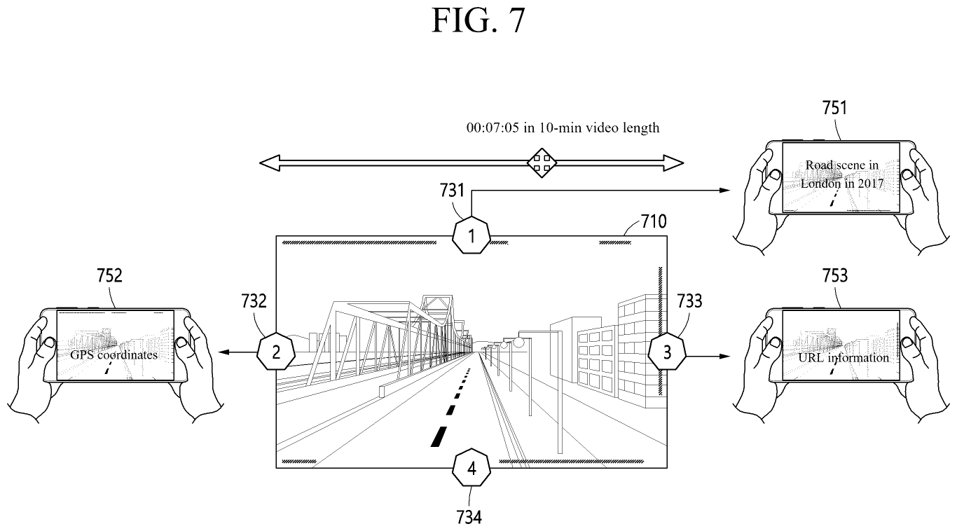

FIG. 7 illustrates still other examples of an operation of the content expansion device of FIG. 1.

Referring to FIG. 7, a processor (e.g., processor 200 of FIG. 1) may provide a plurality of pieces of information related to content using a plurality of codes 731, 732, 733, and 734. A location of each of the plurality of codes 731, 732, 733, and 734 may be different. Each of the plurality of codes 731, 732, 733, and 734 may be embedded at an arbitrary location of an image 710.

In the example of FIG. 7, the code 731 may be located at the top of the image 710, the code 732 may be located at the left side of the image 710, the code 733 may be located at the right side of the image 710, and the code 734 may be located at the bottom of the image. In the example of FIG. 7, although a code is expressed as being located at the edge, the code may be located inside or outside an object (e.g., person or goods) included in the content depending on example embodiments.

Each of the plurality of codes 731, 732, 733, and 734 may correspond to different information. For example, the code 731 may correspond to information on a time and a place at which the image 710 is captured, and the code 732 may correspond to GPS coordinates at which the image 710 is captured. The code 733 may correspond to a URL related to the image 710. The code 734 may correspond to a playback progress rate of the content.

Although FIG. 7 illustrates that the number of embedded codes is four, the number of codes embeddable in the image 710 may be less than or greater than 4 depending on example embodiments. For example, a plurality of codes may be located at one corner.

The processor 200 may use some of the plurality of codes 731, 732, 733, and 734 to identify a content providing device (e.g., TV). When the content providing device is connected to a local network and when a smartphone is connected to the same local network, the processor 200 may use some of the plurality of codes 731, 732, 733, and 734 to identify the content providing device.

When the content providing device is not connected to a network and receives only a broadcast signal, a code for identifying the content providing device may not be provided.

The processor 200 may continuously play back the content through a plurality of content providing devices using the plurality of codes 731, 732, 733, and 734. For example, the processor 200 may continuously play back a single piece of content using a content playback device paired with a single content playback device.

FIGS. 8A to 8C illustrate still other examples of an operation of the content expansion device of FIG. 1.

Referring to FIGS. 8A to 8C, a receiver (e.g., receiver 100 of FIG. 1) may receive a request related to a viewpoint of content from a user of the content. The receiver 100 may receive an image 870 embedded with a code 850.

A processor (e.g., processor 200 of FIG. 1) may acquire information related to the content by processing the code 850. The information related to the content may include information related to a viewpoint of the content and source information of the content. The processor 200 may acquire a plurality of viewpoint contents corresponding to angles of a plurality of cameras 831, 832, and 833 used to capture the content based on information related to the content. The plurality of cameras 831, 832, and 833 may correspond to different viewpoints, respectively.

For example, the camera 1 831 may generate viewpoint content 871 by capturing the content that includes the image 870 from a left angle, the camera 2 832 may generate viewpoint content 872 by capturing the content that includes the image 870 from the front, and the camera 3 833 may generate viewpoint content 873 by capturing the content that includes the image 870 from the right.

The processor 200 may acquire source information of the plurality of viewpoint contents 871, 873, and 875 by processing the code 850 and may provide at least one viewpoint content among the plurality of viewpoint contents 871, 873, and 875 to a user based on a request related to a viewpoint. That is, the processor 200 may provide content by changing a viewpoint of the content according to a taste of a content user.

The processor 200 may provide different playback progress rates of the plurality of viewpoint contents 871, 873, and 875 in response to a request from the user for changing a playback location.

The receiver 100 may receive a request related to a plot of content from the user of the content.

The processor 200 may acquire a plurality of sub-contents having different plots in the content based on information related to the content. The processor 200 may provide at least one sub-content among the plurality of sub-contents to the user based on the request related to the plot. Through this, the processor 200 may provide the plurality of sub-contents having different endings to the content user in response to a request from the content user.

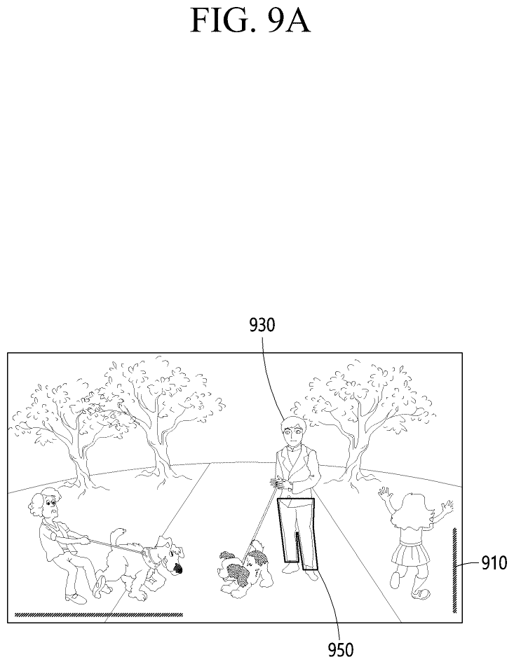

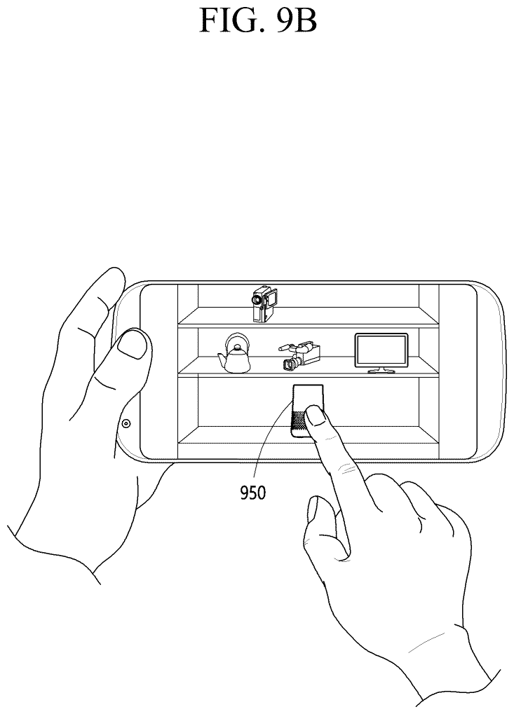

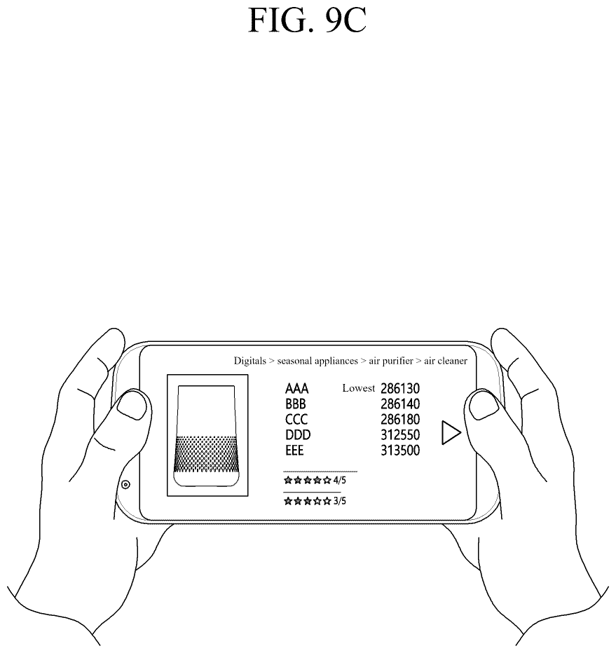

FIGS. 9A to 9E illustrate still other examples of an operation of the content expansion device of FIG. 1.

Referring to FIGS. 9A to 9E, in the example of FIG. 9 with a processor (e.g., processor 200 of FIG. 1), a receiver (e.g., receiver 100 of FIG. 1) may receive an image embedded with a code 910 and may output the received image to the processor 200.

The processor 200 may acquire information related to content by processing the code 910. The information related to the content may include information related to a person 930 and goods 950.

The processor 200 may provide information on the person 930 or the goods 950 in response to a request from a content user. For example, as in the example of FIG. 9B, the processor 200 may provide information on the person 930 or the goods 950 in response to a touch input from the content user on the person 930 or the goods 950.

Information related to the person 930 may include information on a name, an age, a nationality, a height, a spouse, and an occupation of the person 930. Information related to the goods 950 may include a name, a price, and a purchase place of the goods 950.

The example of FIG. 9A may represent a case in which the goods 950 correspond to pants and the example of FIG. 9B may represent a case in which the goods 950 correspond to an air purifier. The processor 200 may provide a name, a price, and a purchase place of the goods 950 to the content user. The processor 200 may induce the content user to purchase the goods 950 by providing a URL for purchasing the goods 950 to the content user.

In the examples of FIGS. 9C and 9D, basic information on the goods 950 may be provided by a content producer. The content user may generate additional information on the goods 950 included in the content, and the processor 200 may encode the additional information and may insert an additional code into the content. The additional information may include a model name, a lowest price and a purchase place, ratings, and reviews of the goods 950.

The processor 200 may provide a return function to return a screen from information related to the content to the content. The processor 200 may provide a lock function. The user may limit a selection on information that the user does not desire to provide or desires to fix using the lock function.

The processor 200 may exclude a configuration that is not desired to be viewed from the content through a code. For example, the processor 200 may process the code and may provide the content user with only pure content excluding information, such as advertising, next episode information, title, broadcasting company or a message included in the content. The processor 200 may provide a code that excludes an undesired configuration only to the content user that provides cost.

The processor 200 may generate an additional code by generating additional information related to the content and by encoding the additional information and may insert the generated additional code into the content.

The processor 200 may provide expanded content into which the additional information is inserted to the content user. The additional information may include information related to the person 930 included in the content, information related to the goods 950 included in the content, and information related to a place included in the content.

Information related to the place may include an address of the place, transportation to reach the place, an amount of time used to reach the place, and price to use the transportation.

The processor 200 may provide a keyword autocompletion function when searching for the person 930 or the goods 950. The processor 200 may provide the keyword autocompletion function based on information included in the content or additional information added by the content user.

The processor 200 may calculate and provide accuracy of the person 950 based on an image included in the content. For example, the processor 200 may provide information on the person 930 provided from participants (e.g., content users) and accuracy of the information.

The processor 200 may evaluate an information provider based on the accuracy and may preferentially display an information provider having a high evaluation. The processor 200 may provide a reward (e.g., coupon, mileage, cash, etc.) to the preferentially displayed information provider.

The processor 200 may receive a question about the person 930 or the goods 950 from the content user. The processor 20 may receive price for the question and may pay the price to a content user that provides an answer to the question.

In response to a touch input on the person 930, the processor 200 may provide additional information (e.g., text, image, or URL) provided from other content users. The processor 200 may provide product information related to the person 930. For example, as in the example of FIG. 9E, the processor 200 may provide product information related to the person 950 using a “More” button.

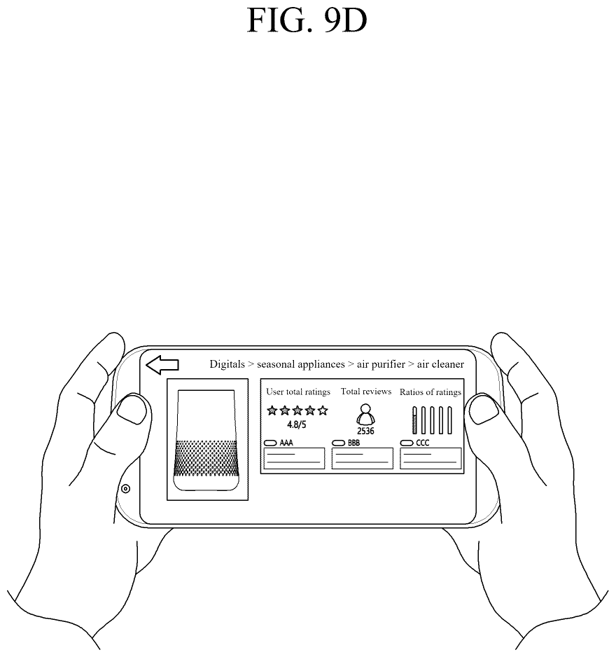

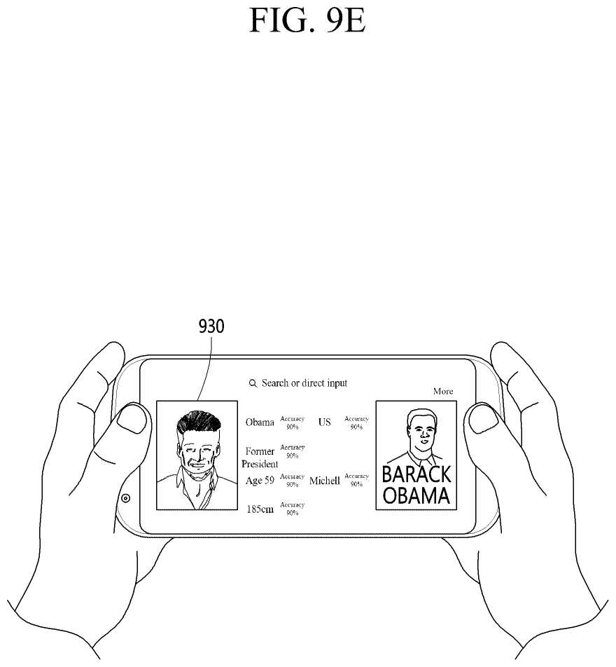

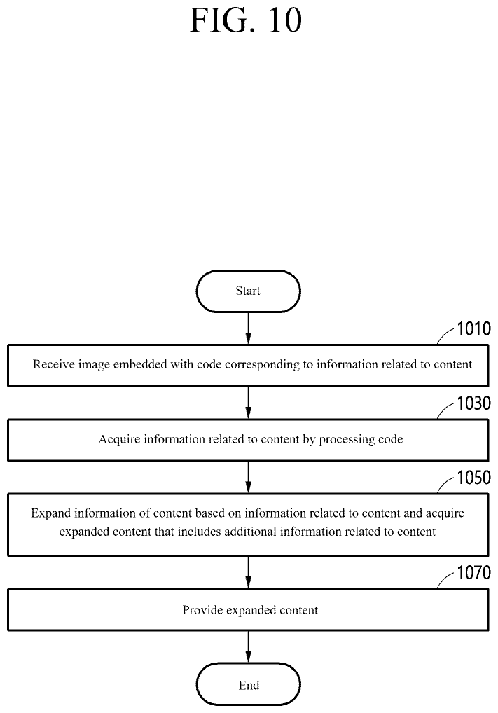

FIG. 10 is a flowchart illustrating an operation of the content expansion device of FIG. 1.

Referring to FIG. 10, in operation 1010, a receiver (e.g., receiver 100 of FIG. 1) may receive an image embedded with a code corresponding to information related to content. The code may be identified by capturing the content using an image sensor.

The code may be embedded in the content in a form of a set of pixels included in the image. The code may be encoded based on a length of the set of pixels that include the code, a ratio of the length of the set of pixels that include the code to a size of the image, a color temperature of pixels that include the code, and a shape of the set of pixels that constitute the code.

Information related to the content may include source information of the content, a playback time of the content, a playback progress rate of the content, location information related to the content, information related to an object included in the content, and an angle of a camera at which the content is captured.

In operation 1030, a processor (e.g., processor 200 of FIG. 1) may acquire information related to the content by processing the code. The processor 200 may acquire an Internet address that includes information related to the content by decoding the code. The processor 200 may acquire information related to the content based on the Internet address.

In operation 1050, the processor 200 may expand information of the content based on information related to the content and may acquire the expanded content that includes the additional information related to the content.

The processor 200 may generate an additional code by generating additional information related to the content and by encoding the additional information. The processor 200 may insert the generated additional code into the content.

The additional information may include information related to a person included in the content, information related to goods included in the content, and information related to a place included in the content. The information related to the person may include a name, an age, and an occupation of the person. The information related to the goods may include a name, a price, and a purchase place of the goods. The information related to the place may include an address of the place, a transportation to reach the place, an amount of time used to reach the place, and price to use the transportation.

The received image may include at least a portion of content provided from a first content providing device. The processor 200 may continuously provide the content to a second content providing device based on source information of the content and a playback progress rate of the content that are included in the information related to the content.

The receiver 100 may receive a request related to a viewpoint of the content from a user of the content and may output the request related to the viewpoint to the processor 200.

The processor 200 may acquire a plurality of viewpoint contents corresponding to angles of a plurality of cameras used to capture the content based on the information related to the content. The processor 200 may provide at least one viewpoint content among the plurality of viewpoint contents to the user based on the request related to the viewpoint.

The receiver 100 may receive a request related to a plot of the content from the user of the content and may output the request related to the plot to the processor 200.

The processor 200 may acquire a plurality of sub-contents having different plots in the content based on the information. The processor 200 may provide at least one sub-content among the plurality of sub-contents to the user based on the request related to the plot.

In operation 1070, the processor 200 may provide the expanded content.

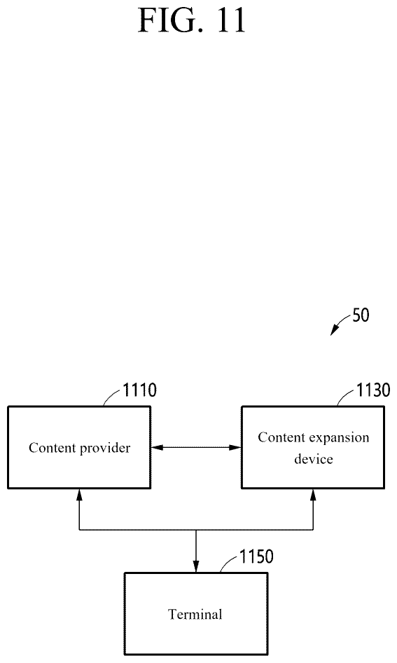

FIG. 11 is a schematic block diagram illustrating a content expansion system according to an example embodiment.

Referring to FIG. 11, a content expansion system 50 may include a content provider 1110, a content expansion device 1130, and a terminal 1150.

The content provider 1110 may provide content to a user through the terminal 1150. The content expansion device 1130 may combine the content provided from the content provider 1110 with additional information and may provide the content combined with the additional information to the terminal 1150.

The terminal 1150 may be implemented in a content providing device that includes a display. Alternatively, the terminal 1150 may be implemented in a server outside the content providing device. The terminal 1150 may be implemented in a PC, a data server, or a portable device.

The portable device may include a laptop computer, a mobile phone, a smartphone, a tablet PC, a mobile Internet device (MID), a personal digital assistant (PDA), an enterprise digital assistant (EDA), a digital still camera, a digital video camera, a portable multimedia player (PMP), a personal navigation device or a portable navigation device (PND), a handheld game console, an e-book, or a smart device. The smart device may be implemented as a smart watch, a smart band, or a smart ring.

The content expansion device 1130 may be implemented in the server. The server may include a computer program (server program) or a device as a computer system that provides information or a service to a client through a network.

The content expansion device 1130 includes a receiver (e.g., receiver 100. of FIG. 1) and a processor (e.g., processor 200 of FIG. 1). The content expansion device 1130 may further include a memory (e.g., memory 300 of FIG. 1).

The receiver 100 may receive meta information corresponding to a code related to the content. The receiver 100 may receive a request related to additional information. The receiver 100 may receive an access request for combining the additional information from a content provider.

The receiver 100 may output the received meta information to the processor 200.

The meta information may include a location of the content, a title of the content, a producer of the content, a playback time of the content, a resolution of the content, capacity of the content, and a playback progress rate of the content.

The processor 200 may generate additional information related to the content based on the meta information. The additional information may include subtitle information on the content, location information included in the content, purchase information on goods displayed in the content, donation information related to the content, and interior information related to the content.

The processor 200 may combine the content with the additional information and may generate the content combined with the additional information.

The processor 200 may generate a timeline corresponding to the playback progress rate of the content. The processor 200 may allocate an additional information generation space corresponding to the timeline.

The processor 200 may provide the content combined with the additional information to the terminal 1150. The processor 200 may search for additional target information in response to the request related to the additional information. The processor 200 may provide the additional target information to the terminal 1150.

The processor 200 may determine a target timeline included in the content based on the request related to the additional information. The processor 200 may search for the additional target information corresponding to the target timeline.

The processor 200 may set an access right and an edition right for combining the additional information to the additional content provider based on the access request.

The code may include an audio signal. The processor 200 may search for the content combined with the additional information based on the audio signal and may provide the same to the terminal.

Matters not described in FIG. 11 in relation to the receiver 100, the processor 200, and the memory 300 may be the same as FIG. 1.

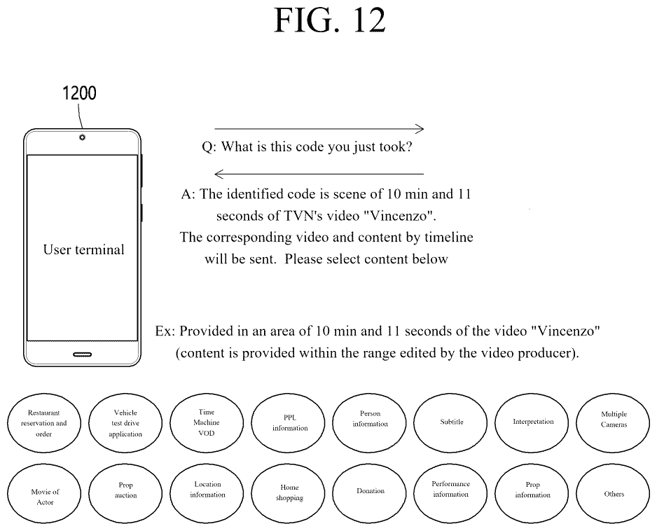

FIG. 12 illustrates an example of additional information provided from a content expansion device.

Referring to FIG. 12, a processor (e.g., processor 200 of FIG. 1) may generate additional information related to content based on meta information. The additional information may include subtitle information on the content, location information included in the content, purchase information on goods displayed in the content, donation information related to the content, and interior information related to the content.

The processor 200 may combine the content with the additional information, and may provide the content combined with the additional information to a user through a terminal 1200. The meta information may be recognized through a code included in the content. The terminal 1200 may recognize the meta information from an identification code displayed on a display on which the content is being played back. The code may include unique information on the content or meta information and time information (e.g., timeline) of the content.

When the terminal 1200 reads the code and transmits unique information to a server (e.g., content provider (e.g., content provider 1110 of FIG. 11) or content expansion 1130 of FIG. 11), which content is at which point on the server may be known.

According to various example embodiments, the meta information may further include a title of the content, a length of the content, an editor of the content, global positioning system (GPS) location information, a codec of the content, and a resolution of the content.

Although the resolution of the content and the title of the content are edited, the same content may be played back at the same time. In this case, the content expansion device 1130 may provide the additional information to the terminal 1200.

The terminal 1200 may read unique information on the content by capturing the code included in the content through a camera and may read time information of the content and then verify the content and a playback progress rate of the content to request a server (e.g., content provider 1110 or content expansion device 1130 of FIG. 11) for.

The terminal 1200 may receive content being played back and additional information corresponding to a playback progress rate from the content expansion device 1150 and may provide the same to the user.

The additional information may include restaurant reservation and order, vehicle test drive application, a time machine video on demand (VOD), product placement (PPL) information, person information of the content, subtitle of the content, interpretation for the content, multiple camera scenes corresponding to the content, information on another content in which an actor of the content appears, a prop auction, location information related to the content, home shopping information related to the content, donation information related to the content, and performance information related to the content.

The content provider 1110 may generate a code and a timeline corresponding to the content. The content provider 1110 may edit content being directly provided based on the generated additional information or may edit a participation and user information providing participation range of the content provider 1110.

When the user reads the code using the camera of the terminal and gives a question related to contents, the processor 200 serves to inform the user of what time period of which content is and which content is related based on information on the content (e.g., meta information or timeline).

The processor 200 may perform relaying such that the content provider 1110 may easily combine the content with the additional information.

The content expansion device 1130 may verify information on the content requested by the terminal 1200 and may distribute the content and additional information corresponding to the timeline of the content to the terminal 1200 and another user terminal.

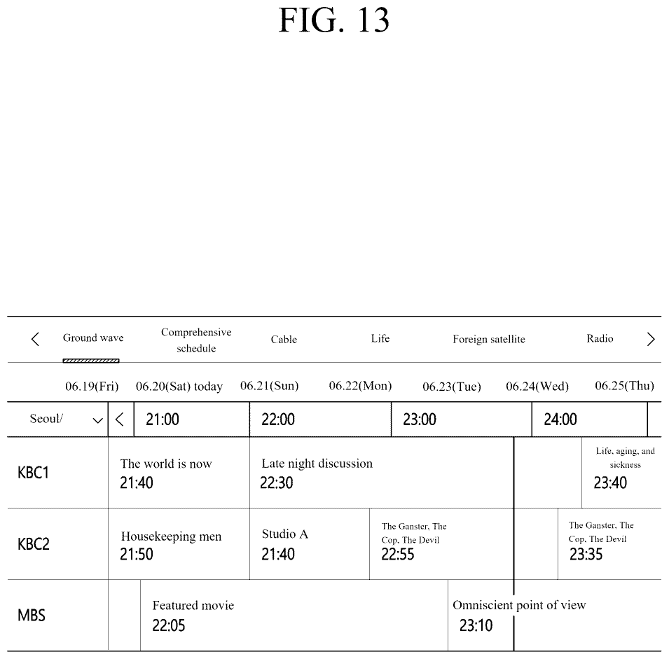

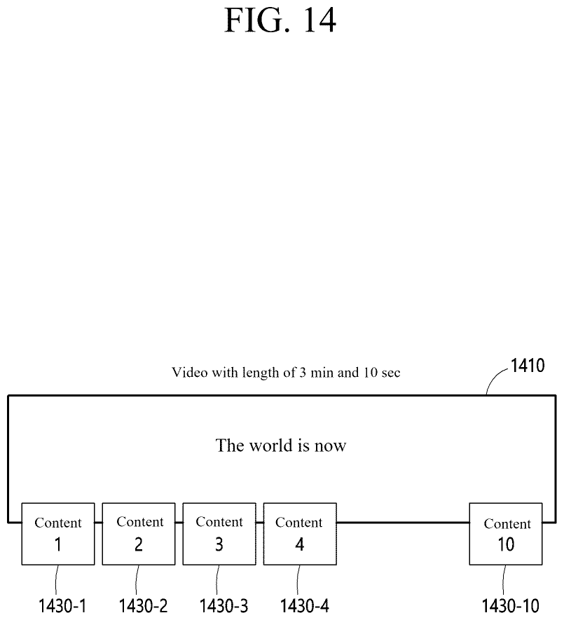

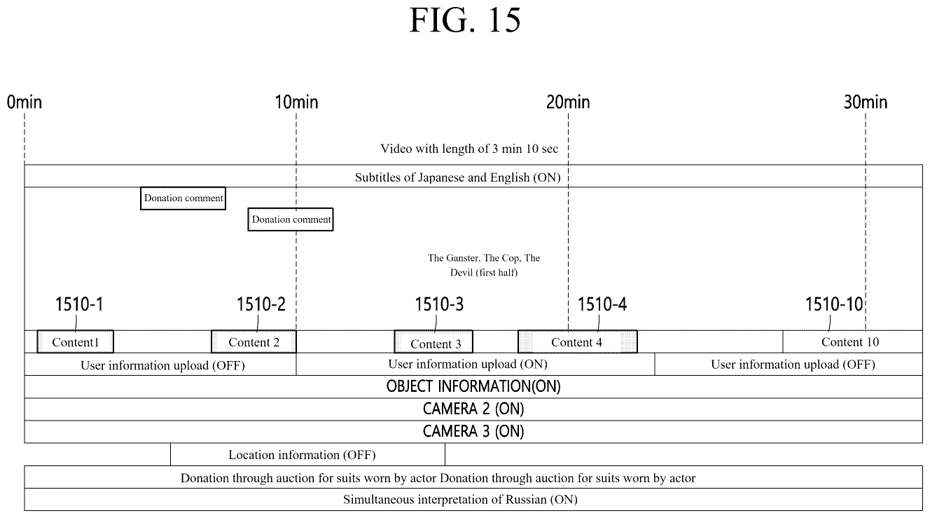

FIG. 13 illustrates an example of a schedule of a content provider, FIG. 14 illustrates an example of additional information according to a timeline, and FIG. 15 illustrates an example of an additional information generation space.

Referring to FIGS. 13 to 15, a processor (e.g., processor 200 of FIG. 1) may generate a timeline corresponding to a playback progress rate of content. The processor 200 may allocate an additional information generation space corresponding to the timeline.

For example, the processor 200 may generate a timeline corresponding to a playback progress rate of content, “The world is now,” in the schedule of FIG. 13. The processor 200 may allocate a plurality of additional information generation spaces (e.g., additional information 1430-1 to 1430-10) to content that is a video 1410, “The world is now.” Although the example of FIG. 14 illustrates an example in which the number of additional information generation spaces is 10, the number of additional information generation spaces may be less than or greater than 10 depending on example embodiments.

The processor 200 may provide the content combined with the additional information to the terminal. The processor 200 may search for additional target information in response to a request related to the additional information. The processor 200 may provide the additional target information to the terminal.

The processor 200 may determine a target timeline included in the content based on the request related to the additional information. The processor 200 may search for the additional target information corresponding to the target timeline.

The timeline may further include information capable of identifying identity of the content through the code and information on a viewpoint of a scene that is currently being played back.

The example of FIG. 15 may represent an additional information generation space based on a timeline of content “The Gangster, The Cop, The Devil.” The processor 200 may allocate additional information generation spaces 1510-1 to 1510-10, may grant an edition right to a person that desires to edit the content, and may provide additional information, such as donation, multiple cameras, and simultaneous interpretation.

The processor 200 may provide a member registration function. The processor 200 may receive additional information of content from a registered member and may generate a unique identification code for the content.

The processor 200 may generate a timeline based on a playback time of the content. Although an editor of additional information of the content inputs only meta information to a server without a file, the processor 200 may assign an edition right corresponding to a timeline of the content.

A file name of the content within the meta information may be edited and/or modified, but a length of the encoded content may not vary. Although a user of the content edits the content using encoding and duplicating, an original name may be valid. Although the user gives a question to the server by changing the name, the processor 200 may provide information on the copied content based on original information.

If the user uploads a content file to the server, the processor 200 may read and recognize meta information of the file and may allocate an edition right for the content provider 1110 for an access range by timeline.

When the file of the content is uploaded, the processor 200 may make a snapshot and sound as a database (DB). When the user gives a question about meta information using only an audio signal instead of a code displayed on a screen, the processor 200 may extract meta information of the content by processing the audio signal. When the processor 220 receives the query based on the extracted meta information, the processor 200 may provide additional information to the user based on the extracted meta information.

The processor 200 may receive a broadcast time schedule as shown in the example of FIG. 13 and may generate meta information on broadcasts of which broadcast time has passed, and may provide the same to the terminal. The processor 200 may receive meta information related to the content from an owner of the content and may store the same in a memory (e.g., memory 300 of FIG. 1).

The processor 200 may provide a member registration function. When log-in is performed with an official ID of a broadcasting company joined through the member registration function, the processor 200 may allocate a base corresponding to each piece of content according to the schedule as shown in the example of FIG. 13. The processor 200 may set a participation and edition right of a content provider.

The processor 200 may receive meta information of content for providing additional information and a request related to the additional information, may combine the content with the related additional information, and may distribute the same to the terminal. Here, although meta information, such as a resolution or an editor, is partially different, the corresponding content may be recognized as the same content if capacity (or quantity) of the content is identical.

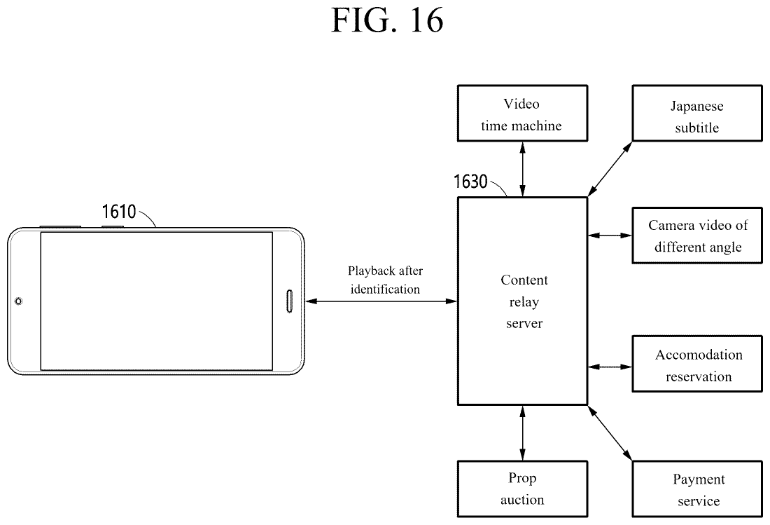

FIG. 16 illustrates an interaction between a terminal and a content relay server.

Referring to FIG. 16, a content expansion device (e.g., content expansion device 1130 of FIG. 11) may be implemented in a content relay server 1630. A processor (e.g., processor 200 of FIG. 1) may combine content with additional information and may provide the content combined with the additional information to a terminal 1610.

The processor 200 may provide an interface for editing the additional information to a content provider (e.g., user or content provider) for the content.

The processor 200 may distribute additional information corresponding to a timeline to the terminal 1610. The processor 200 may provide a payment system associated with the additional information.

A memory (e.g., memory 300 of FIG. 1) may store meta information on each piece of content. The processor 200 may distribute the additional information according to the timeline to the terminal 1610, based on the stored meta information.

The processor 200 may optionally set an edition right for the content and the additional information to the user and may set an access range of associated content.

Editing of the additional information may be input using a smart pen (e.g., an S pen or an apple pen). The processor 200 may combine the content with the additional information input through the smart pen.

The processor 200 may split the content into scenes and may set a timeline based on the split scene. The processor 200 may allocate a single additional information generation space to a single scene to recognize the timeline corresponding to the split scene.

The processor 200 may provide information on revenue generated based on the additional information to the user while providing the content combined with the additional information to the terminal 1610.

The processor 200 may designate props appearing in the content, suits or shoes worn by characters in the content, and may provide an auction function at a designated time. The processor 200 may provide a donation system for donating fund generated through the auction function.

For example, the processor 200 may provide a money management system that may directly perform a donation to a person appearing in the content using a payment system in association with a financial institution.

The processor 200 may generate contact information for estimating and consulting on an interior appearing in the content as the additional information and may combine the same with the content.

The processor 200 may recognize a playback length of corresponding content and the content based on length information of the content for each content of YouTube channel. The processor 200 may limit the range of additional information combinable with the recognized content.

In the case of receiving a URL of the content, the processor 200 may combine the additional information based on the URL and may provide the additional information even with respect to streaming content or external content not stored in the memory 300.

The processor 200 may receive meta information and information on a timeline of content being played back in the terminal 1610, may compare the received meta information and information on the timeline to the meta information stored in the memory 300, and may combine the content with the additional information in real time.

FIG. 17 illustrates another example of additional information provided from a content expansion device.

Referring to FIG. 17, a processor (e.g., processor 200) may provide an augmented reality (AR) image to a terminal 1700. When the terminal 1700 captures a screen (e.g., TV screen) on which content is played back with a camera by providing additional information on the AR image to the terminal 1700, the processor 200 may identify content based on meta information corresponding to a code and may provide the AR image related to the identified content to the terminal 1700. Here, the processor 200 may provide the additional information to output, to the terminal 1700, only an image that is not displayed on the screen on which the content is being played back.

The processor 200 may receive a sound signal through the terminal 1700 and may synchronize the content and the AR image. The processor 200 may identify the content by identifying the meta information included in the code.

The processor 200 may receive a request related to the additional information from the terminal 1700 and may optionally provide the additional information combined with the content to the terminal 1700 based on the meta information and timeline information of the content. The processor 200 may serve to relay users and content providers that desire to provide additional information by combining the content with the additional information based on the timeline. The processor 200 may provide an application programming interface (API) for content providing.

The processor 200 may provide another content in which a character appears, home shopping, additional live broadcasting, a donation function, and a commercial transaction service in each piece of content and timelines as the additional information.

The processor 200 may provide additional information to the terminal 1700 in the form of the AR image. For example, additional information of FIG. 17 may be provided in the form of the AR image.

The processor 200 may analyze the code included in the content and may performing pairing of the terminal 1700 and a TV. The processor 200 may receive a request related to the additional information of the content from a remote controller and may perform a relay function to make it possible to purchase goods included in the additional information through the remote controller.

The processor 200 may provide an information DB for the content. The processor 200 may directly provide information on the content displayed on the TV to a TV manufacturer.

The processor 200 may provide the additional information in the form of the AR image using a smart glass. The smart glass may recognize the code by capturing the content and may acquire meta information from the code. The processor 200 may receive the meta information from the smart glass and may transmit the additional information to the smart glass based on the received meta information.

For example, the user may read the code through the smart glass, may receive the additional information included in the content from the processor 200, and may view the same through AR. The smart glass may receive voice of the user through a microphone, may output the received voice to the processor 200, and may receive the additional information. For example, the processor 200 may receive voice, such as “OK Google, show the current content!”, “OK Google, return it 5 minutes ago,” and “OK Google, order the clothes Vincenzo is wearing,” from the smart glass and may retrieve additional information to be provided to the user based on the received voice and then may provide the retrieved information.

The processor 200 may combine content provided from an over-the-top (OTT) service provider with the additional information and may provide the same to the user. Since an OTT service may acquire identity of the content and a playback progress rate of the content without a process of reading the code with the camera, the content may be independently provided by providing additional information related to the content to a content playback device (e.g., TV) and additional information of the content may be easily provided by manipulating the remote controller.

The processor 200 may receive meta information related to the content from a content providing platform, such as YouTube, and may generate additional information based on the received meta information and may provide the same to the user.

The processor 200 may provide information on things and a person appearing in the content to the user, may combine donation or information on the things and the person with the content without a separate secondary search or telephone contact, and may provide a donation system and a purchase and reservation service for the things and the person.

The processor 200 may fetch existing code information to codeless content and may provide the same such that an (online or public) TV may display a coded image.

For example, a function of adding a code may be normally in an OFF state in the terminal 1700, but when a camera program of the terminal 1700 operates, a code function may run through a TV connected to the same communication network (e.g., Wi-Fi) as the terminal 1700. Here, the communication network may include Bluetooth and ultra-wideband (UWB).

The processor 200 may transmit a current TV and playback information (e.g., meta information and timeline of the content) of the TV within a communication range through a communication protocol, such as Bluetooth or UWB, without pairing with the TV, and may recognize a transmitted signal as a code, and may provide additional information to the terminal 1700.

The processor 200 may transmit information on content currently being played back to the terminal 1700 using the communication protocol. A code function may be turned OFF or turned ON with a remote controller according to a manipulation of the user.

The processor 200 may receive digital channel information and time information received from the TV and may insert a code in the middle of content being played back on the TV while the content is being broadcasted on the TV.

The processor 200 may display received code information for a short period of time or may continuously display the same, or may allow the user to determine whether to display the code information, in the case of switching a TV channel. The processor 200 may invoke online sub-item information from the Internet and may provide the same to the user through the terminal 1700 or the content playback device. The processor 200 may play back the content from a predetermined playback point in time based on meta information of the code.

The processor 200 may differently invoke local information. The processor 200 may provide content corresponding to a camera filter class to the terminal 1700 for each service. The processor 200 may provide age-appropriate content and additional information in consideration of age of the user. The processor 200 may receive donation from the user and perform donation.

The processor 200 may load authorized item information corresponding to the content and may provide the same together when playing back the content. The content provider may directly edit and input additional information corresponding to a timeline through the content expansion device. The content provider may secondarily insert PPL information appearing in the content by timeline as the additional information.

The processor 200 may filter out profanity and ambiguous information from additional description included in additional information that is generated through participation of other producers or users that view the content. The processor 200 may provide a recommendation phrase to generate accurate content.

Editing of relevant code information that is officially transmitted from a broadcasting company may be primarily owned by the broadcasting company (content provider) and may control the participation range of the user or creators of additional information.

Other relevant codes (different interpretation for the corresponding content) may be invoked to display related information on the smartphone.

When the content is streamed or downloaded from the server and played back without identifying the code on the TV, the processor 200 may verify identity of the content by recognizing already generated meta information without a need to identify the content and thus, may provide additional information to a smartphone or a TV of the user in the same way as reading the code.

The processor 200 may transmit the content combined with the additional information to a TV or OTT that plays back or rebroadcasts the content. The processor 200 may make the code visible on the TV when a camera app of reading the code is executed on a smartphone connected to the same Wi-Fi. The processor 200 may simply produce additional information by uploading a broadcast script or a subtitle to a device in which the content is stored (e.g., content provider or arbitrary server) and by mapping basic information on a character and a timeline. When the script or the subtitle is uploaded, the processor 200 may parse the uploaded script or subtitle in a format understandable by the server and may use the same as additional information.

The processor 200 may provide additional information on a homepage in which the content is provided. The processor 200 may overlay and provide additional information on the homepage that provides images or videos. For example, the processor 200 may provide the additional information on the homepage made with HyperText Markup Language (html).

The processor 200 may overlay and provide additional information (e.g., prop information, person information, or location information) related to an image, a video, or content on an html homepage that provides the content (e.g., image, video, or text).

The user may select whether to view additional information directly provided from a PC, whether to turn ON a code option for content and view only information in AR through the terminal 1700, or whether to read a code and to invoke and view the same through the terminal 1700.

The content provider may provide content in which additional information is overlaid to a plurality of users by providing the content to a homepage and by registering the additional information to the content expansion device, and may earn revenue according to the number of times the users view an image or a video posted on the homepage without a separate shopping mall.

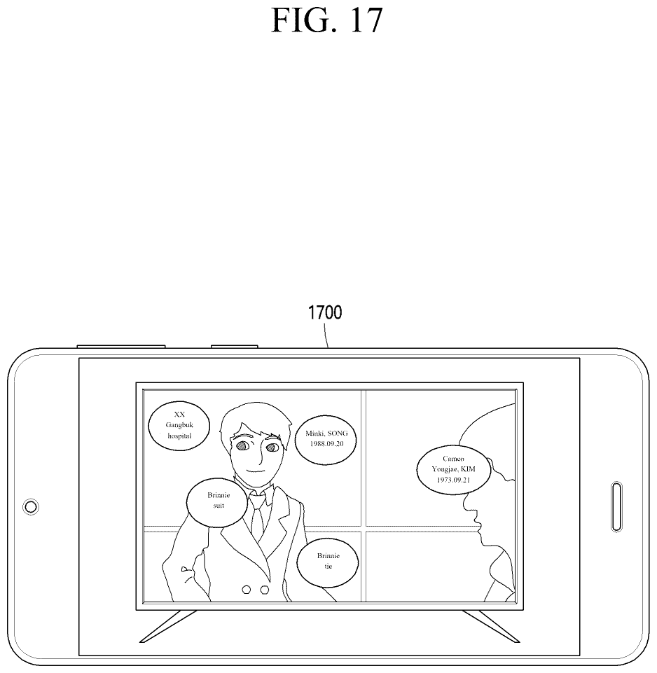

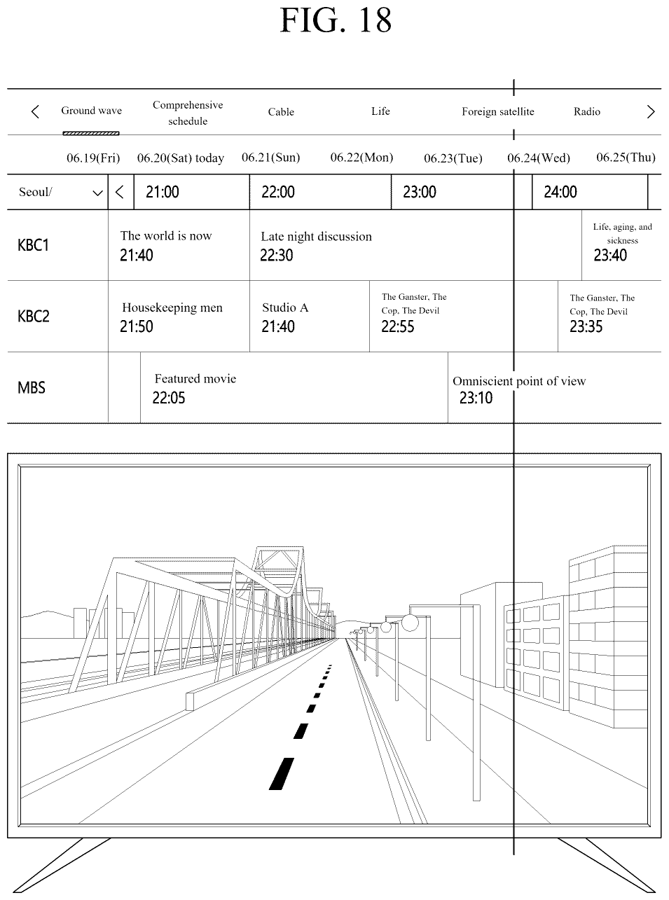

FIG. 18 illustrates an example of describing additional information provided according to a timeline, and FIG. 19 illustrates an example of describing a code recognition operation of a terminal.

Referring to FIGS. 18 and 19, when it is difficult to recognize a code, a processor (e.g., processor 200 of FIG. 1) may distinguish content and a timeline by recognizing voice and by mapping the recognized voice and text information of an updated script or subtitle.

The processor 200 may identify the content through voice recognition, may distinguish a current program and timeline, and may provide relevant additional information. In the case of a pre-recorded drama or video, the processor 200 may pre-upload wavelengths of sound and frames included in the content to a server, may make the same as a database, and may identify the content and the timeline. In the example of FIG. 18, the processor 200 may distinguish accurate content and timeline by linking a cable TV and a public TV schedule.

The processor 200 may distinguish various images by recognizing voice and by making a wavelength for each voice as a database. The processor 200 may more accurately identify content using subtitle information and overlay information of the content. The processor 200 may recognize an overlaid broadcasting company log or title and may use the same as a mark for identifying the content.

The processor 200 may enhance accuracy of image recognition by distinguishing a current broadcast from a previous broadcast with a mark capable of distinguishing a live broadcast from a rebroadcast as a log, an edge, a frame, and the like, on a screen. If corresponding content is absent in a current schedule even with a live broadcast mark, the processor 200 may recognize the aired broadcast as a rebroadcast. The processor 200 may convert voice to a database and may quickly and accurately search for a rebroadcast.

In the case of receiving content in which an image and audio are combined or content that includes only audio, the processor 200 may generate timeline information by mapping a script or a subtitle. The processor 200 may distinguish timelines by performing synchronization with the subtitle of content through voice recognition.

In the case of receiving a script, the processor 200 may mark a playback point in time of the script and subtitle by timeline through synchronization of the script and the subtitle or synchronization with closed caption broadcasting. The processor 200 may adjust the sync of the script to synchronize with a timeline.

The processor 200 may distinguish a subtitle and an actor and action of the actor and may provide different additional information on the actor for each scene in which the actor appears. The processor 200 may compare subtitles corresponding to audio included in content being played back on multiple channels at the same time, may retrieve a matching subtitle (or audio), and may distinguish timeline points from the content.

In the case of marking the content with a live broadcast, the processor 200 may pre-distinguish whether the content is a live broadcast or a rebroadcast, thereby improving a DB search rate and accuracy. The processor 200 may recognize an audio signal by making a pattern of a wavelength of the audio signal included in the content as a DB, may distinguish a timeline from the content, and may provide additional information combined with the corresponding content.

When the processor 200 receives a question transmitted from a terminal 1900 that reads an internal code of the content and reads unique information and a timeline of the content, the processor 200 may provide relevant additional information to the terminal 1900. The unique information may be generated with respect to information related to content of the server in which the content is stored, such as a QR code.

The terminal 1900 may read the timeline, may transmit the question to the processor 200, and may download related additional information. Here, a separate DB comparison operation is not required. Content of the content expansion device may be immediately verified through direct designation and additional information may be downloaded.

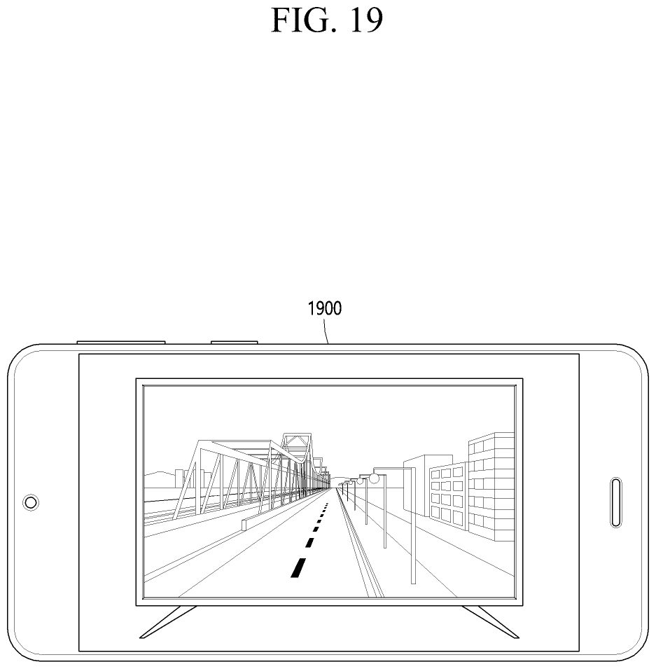

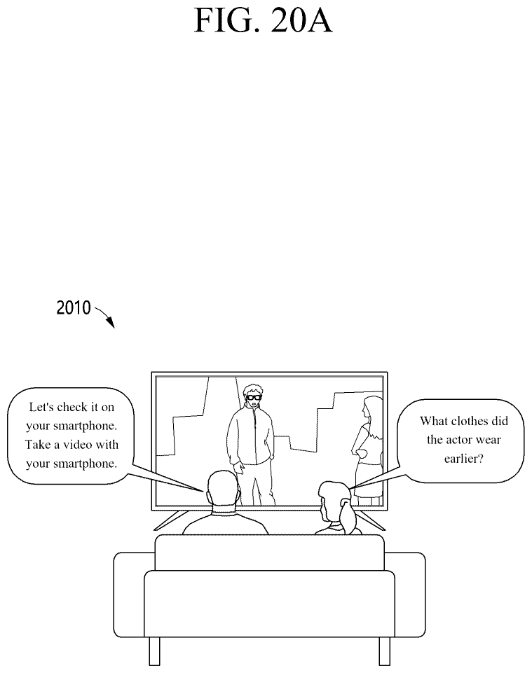

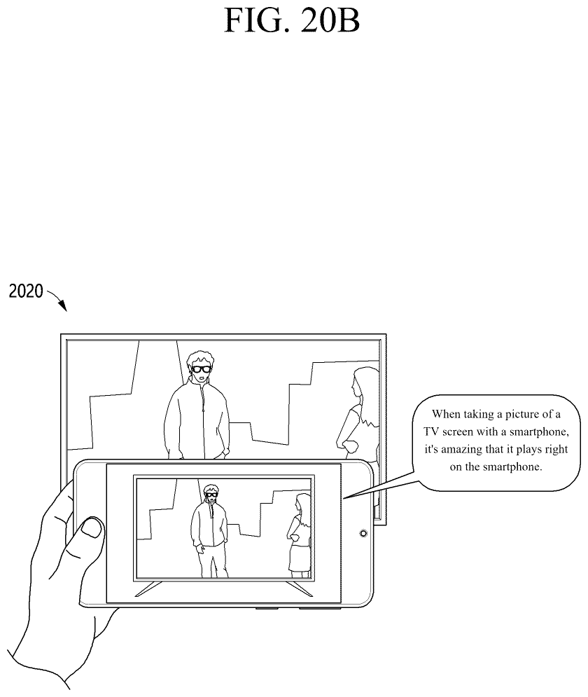

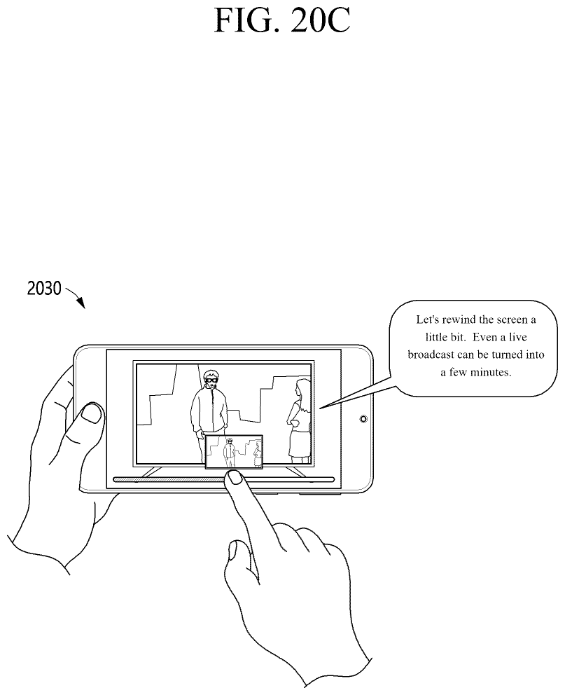

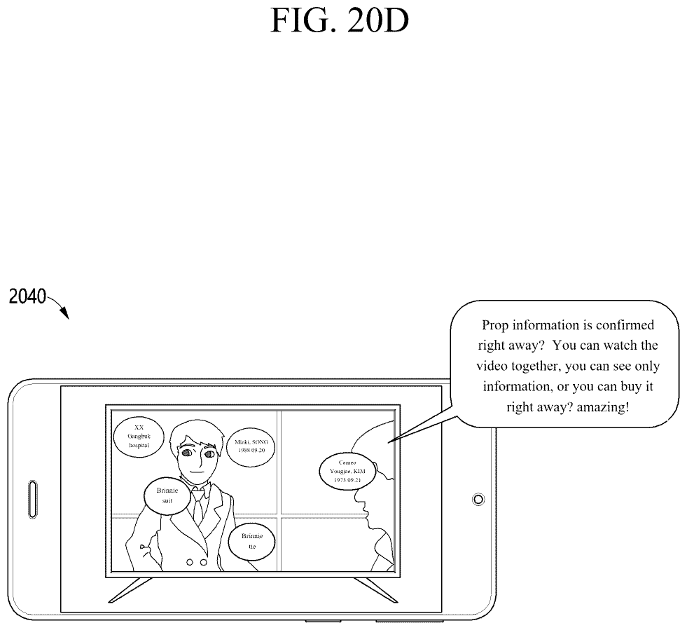

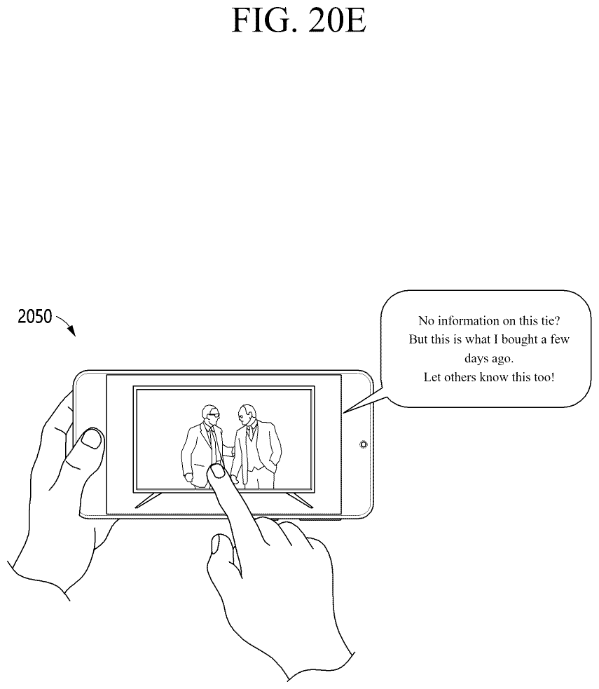

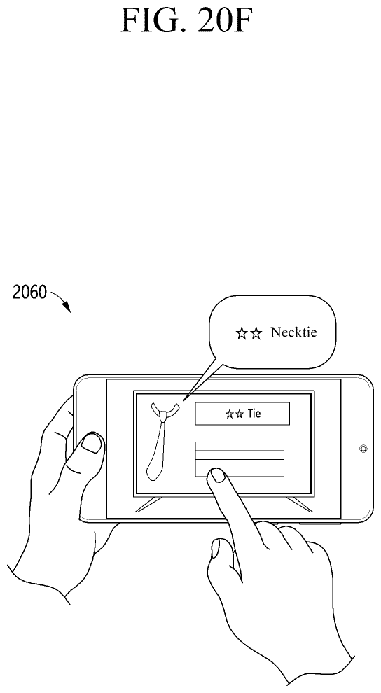

FIGS. 20A to 20F illustrate examples of additional information provided from the content expansion device of FIG. 11.

Referring to FIGS. 20A to 20F, as in the example of FIG. 20A, a processor (e.g., processor 200 of FIG. 1) may provide information on clothes worn by a person appearing in content through a terminal (e.g., smartphone) (2010).

As in the example of FIG. 20B, the processor 200 may provide a playback progress rate of content to a terminal and in this manner, in the case of capturing a screen on which content is being played back in a content playback device (e.g., TV) using a camera of the terminal, the processor 200 may allow the content to be continuously viewed through the terminal (2020).

As in the example of FIG. 20C, the processor 200 may rewind and view previous scenes in time while viewing a screen being viewed with the content playback device through the terminal (2030).

As in the example of FIG. 20D, the processor 200 may provide additional information related to the content (e.g., information on a character, information on clothes and accessories worn by the character, and location information of a place appearing in the content) (2040).

As in the examples of FIGS. 20E and 20F, the processor 200 may receive additional information from a consumer of the content and may generate the content combined with the additional information (2050). The processor 200 may provide the content combined with the additional information to other various content consumers (2060).

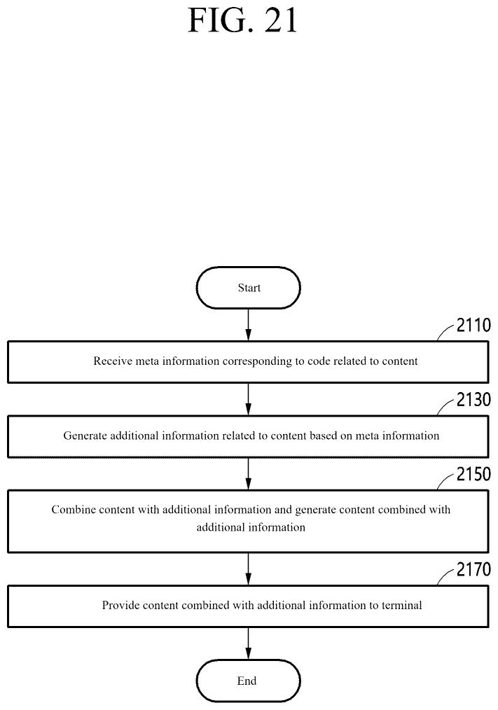

FIG. 21 is a flowchart illustrating an operation of the content expansion device of FIG. 11.

Referring to FIG. 21, in operation 2110, a receiver (e.g., receiver 100 of FIG. 1) may receive meta information corresponding to a code related to content. The receiver 100 may receive a request related to additional information. The receiver 100 may receive an access request for combining the additional information from a content provider. The receiver 100 may output the received meta information to the processor 200.

The meta information may include a location of the content, a title of the content, a producer of the content, a playback time of the content, a resolution of the content, capacity of the content, and a playback progress rate of the content.

In operation 2130, a processor (e.g., processor 200 of FIG. 1) may generate additional information related to the content based on the meta information. The additional information may include subtitle information on the content, location information included in the content, purchase information on goods displayed in the content, donation information related to the content, and interior information related to the content.

In operation 2150, the processor 200 may combine the content with the additional information and may generate the content combined with the additional information.

The processor 200 may generate a timeline corresponding to the playback progress rate of the content. The processor 200 may allocate an additional information generation space corresponding to the timeline.

In operation 2170, the processor 200 may provide the content combined with the additional information to the terminal. The processor 200 may search for additional target information in response to the request related to the additional information. The processor 200 may provide the additional target information to the terminal.

The processor 200 may determine a target timeline included in the content based on the request related to the additional information. The processor 200 may search for the additional target information corresponding to the target timeline.

The processor 200 may set an access right and an edition right for combining the additional information to the additional content provider based on the access request.

The code may include an audio signal. The processor 200 may search for the content combined with the additional information based on the audio signal and may provide the same to the terminal.

The example embodiments described herein may be implemented using hardware components, software components, and/or combination of the hardware components and the software components. For example, the apparatuses, the methods, and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be permanently or temporarily embodied in any type of machine, component, physical equipment, virtual equipment, a computer storage medium or device, or a signal wave to be transmitted, to be interpreted by the processing device or to provide an instruction or data to the processing device. The software also may be distributed over network coupled computer systems so that the software is stored and executed in a distributed fashion. The software and data may be stored by the computer readable storage media.

The methods according to the above-described example embodiments may be configured in a form of program instructions performed through various computer devices and recorded in computer-readable media. The media may also include, alone or in combination with the program instructions, data files, data structures, and the like and examples of the program instructions stored in the media may be specially designed and configured for the example embodiments or may be known and available to one of ordinary in computer software art. Examples of the media include magnetic media such as hard disks, floppy disks, and magnetic tapes; optical media such as CD-ROM and DVDs; magneto-optical media such as floptical disks; and hardware devices that are specially configured to store program instructions, such as read-only memory (ROM), random access memory (RAM), flash memory, and the like. Examples of the program instructions include a machine code, such as produced by a compiler, and an advanced language code that may be executed by the computer using an interpreter.

The hardware device may be configured to operate as one or a plurality of software modules to perform operations of example embodiments, or vice versa.

Although the example embodiments are described with reference to some accompanying drawings, it will be apparent to one of ordinary skill in the art that various technical changes and modifications may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A content expansion device comprising:
a receiver configured to receive meta information corresponding to a code related to content; and
a processor configured to generate additional information related to the content based on the meta information, to combine the additional information with the content and generate the content combined with the additional information, and to provide the content combined with the additional information to a terminal.

2. The content expansion device of claim 1, wherein the meta information includes a location of the content, a title of the content, a producer of the content, a playback time of the content, a resolution of the content, capacity of the content, and a playback progress rate of the content.

3. The content expansion device of claim 1, wherein the processor is configured to generate a timeline corresponding to a playback progress rate of the content, and to allocate an additional information generation space corresponding to the timeline.

4. The content expansion device of claim 1, wherein the receiver is configured to receive a request related to the additional information, and
the processor is configured to search for additional target information in response to the request related to the additional information, and to provide the additional target information to the terminal.

5. The content expansion device of claim 4, wherein the processor is configured to determine a target timeline included in the content based on the request related to the additional information, and to search for the additional target information corresponding to the target timeline.

6. The content expansion device of claim 1, wherein the receiver is configured to receive an access request for combining the additional information from an additional content provider, and
the processor is configured to set an access right and an edition right for combining the additional information to the additional content provider based on the access request.

7. The content expansion device of claim 1, wherein the code includes an audio signal, and
the processor is configured to search for the content combined with the additional information based on the audio signal and to provide the same to the terminal.

8. The content expansion device of claim 1, wherein the additional information includes subtitle information on the content, location information included in the content, purchase information on goods displayed in the content, donation information related to the content, and interior information related to the content.

9. A content expansion method comprising:
receiving content and meta information corresponding to a code related to the content;
generating additional information related to the content based on the meta information;
combining the additional information with the content and generating the content combined with the additional information; and
providing the content combined with the additional information to a terminal.

10. A computer program stored in computer-readable media to implement the method of claim 9 in conjunction with hardware.
